(19) United States
(12) Patent Application Publication
(10) Pub. No.: US 2022/0317095 A1
(43) Pub. Date: Oct. 6, 2022

(54) METHOD, DEVICE AND SYSTEM FOR NON-DESTRUCTIVE EVALUATION OF POLYETHYLENE PIPE JOINTS USING ULTRASOUND AND MACHINE LEARNING

(71) Applicant: JANA Corporation, Aurora (CA)

(72) Inventors: Ken Oliphant, Newmarket (CA); Majid NEZAKAT, Toronto (CA); James BRYCE, Aurora (CA); Roman MAEV, Windor (CA); Fedar SEVIARYN, Windsor (CA); Maryam Shafiei ALAVIJEH, Windsor (CA); Ryan Scott, Windsor (CA)

(21) Appl. No.: 17/455,610

(22) Filed: Nov. 18, 2021

Related U.S. Application Data
(60) Provisional application No. 63/137,245, filed on Jan. 14, 2021.

(51) Int. Cl. G01N 29/44; G01N 29/22; G01N 29/07; G01N 29/04

(52) U.S. Cl. CPC G01N 29/4481; G01N 29/225; G01N 29/07; G01N 29/043; G01N 2291/267

(57) ABSTRACT

An aspect provides an ultrasound device for non-destructive evaluation of a butt-fusion joint or electro-fusion joint, the device comprising: an ultrasonic unit; a transducer operable remotely from the ultrasonic unit and including an ultrasound signal transmitter positionable to transmit the signal towards the joint, and an ultrasound signal receiver positionable to detect a reflection of the signal; a processor; memory including instructions executable by the processor and first data relating to a plurality of first sample joints of acceptable quality and second data relating to a plurality of second sample joints of unacceptable quality; and an output device. The instructions include a machine learning algorithm trained for analysis of the joint and to send assessment output to the output device indicative of whether the joint is of acceptable or unacceptable quality based on the signal reflection and the first and second data.

### CROSS-REFERENCE TO RELATED APPLICATIONS

The present application claims the benefit of U.S. Provisional Application Nos. 63/137,245 filed Jan. 14, 2021, the contents of which are incorporated herein in their entireties.

### FIELD

This disclosure relates generally to non-destructive evaluation or testing (NDE) of polyethylene (PE) pipe joints, and more particularly to non-destructive evaluation or testing (NDE) of butt-fusion joint and electro-fusion polyethylene pipe joints using ultrasound and machine learning (ML).

### BACKGROUND OF THE DISCLOSURE

The use of PE pipes for delivering gas and water has increased for several decades. This increase is attributed to the significant advantages of PE over metal pipes: corrosion resistance, strength-to-weight ratio, lightness, abrasion resistance, flexibility, and cost. Consequently, these pipes have a long predicted service life which is achievable with proper installation and maintenance. The integrity of pipelines is a main concern and the infrastructure industry requires simple and reliable methods for quality assessment. Joints are recognized as the weakest parts of pipelines due to structure disruption and possible errors during welding, which may eventually result in joint failure or pipe damage. Some of the most common methods for joining PE pipes include butt fusion (BF) and electro-fusion (EF) joining.

To eliminate leakage or even potential catastrophes, the integrity of pipes should be examined. Despite that the dominant joining methods are BF and EF, there is not yet a well-established method to nondestructively assess the quality of these types of welds or joints. Currently, the main barriers for nondestructive evaluation (NDE) of BF and EF joints are cost, complicated methods/equipment, and consequently high demand for trained operators. So far, visual inspection and destructive tests are still the main methods of joint quality assurance. The infrastructure industry requires objective, simple, relatively inexpensive, and effective means for nondestructively inspecting BF and EF joints.

With respect to the possibility of ultrasound inspection, relatively poor acoustical properties of the material (inhomogeneity, high attenuation) and peculiarity of joint geometry complicates the task. Simple pulse-echo or pitch-catch test configurations recommended for metal welds exhibit poor performance for PE pipes, and the resulting acoustic signals are difficult to interpret. As a consequence of these issues, the corresponding standard ASTM F600-78 was withdrawn. Phased array systems visualizing full internal structures can provide more stable results, but the high cost of the equipment and the need for experienced personnel are limiting widespread usage of these types of ultrasound systems for PE pipe joint evaluation.

There remains a need for real-time or in-field inspection of PE pipe BF and EF joints, to mitigate against the possibility of catastrophic failures occurring in the field, and the costs associated with lost production output and repairs. Further, there remains a need to more accurately assess the types of defects contained in BF and EF joints through NDE, for improved root cause analyses to improve manufacturing without the need for destructive testing or root cause determination only after failure has occurred in the field. There also remains a need for an NDE system that can avoid the need and cost associated with trained personnel, such as required for phased array systems.

### SUMMARY OF THE DISCLOSURE

In an aspect there is provided an ultrasound device for non-destructive evaluation of a to-be-evaluated joint between a pair of pipes, wherein the to-be-evaluated joint is one of a butt-fusion joint and an electro-fusion joint. The ultrasound device comprises: an ultrasonic unit; a transducer communicatively coupled to the ultrasonic unit and operable remotely from the ultrasonic unit, the transducer including an ultrasound signal transmitter that converts an electrical signal received from the ultrasonic unit into an ultrasound signal, the transmitter positionable to transmit the ultrasound signal towards the to-be-evaluated joint, and an ultrasound signal receiver positionable to detect a reflection of the ultrasound signal; a processor; a non-transient, computer-readable memory including instructions executable by the processor, and further including first data relating to a plurality of first sample joints of acceptable quality and second data relating to a plurality of second sample joints of unacceptable quality; and an output device. The ultrasonic unit, the non-transient, computer-readable memory, and the output device are communicatively coupled to the processor. The instructions include a machine learning (ML) algorithm trained for analysis of the to-be-evaluated joint and to send assessment output to the output device that is indicative of whether the to-be-evaluated joint is of acceptable quality or unacceptable quality, based on the reflection of the ultrasound signal, and based on the first data and the second data.

In another aspect there is provided an ultrasound system for non-destructive evaluation of a butt-fusion joint of a first pair of pipes and an electro-fusion joint of a second pair of pipes. The ultrasound system comprises: a base unit that includes a power supply interface positioned for connection to a power source, an output device, a first signal connector, and a controller that includes a processor and a non-transient, computer-readable memory including instructions executable by the processor, wherein the power supply interface, the output device, the first signal connector, and the memory are communicatively coupled to the processor; a butt-fusion transducer that includes a second signal connector that is shaped to releasably connect to the first signal connector, so as to form a first electrical connection that permits signal transmission between the butt-fusion transducer and the processor, wherein the butt-fusion transducer further includes a first ultrasound transmitter that converts first electrical signals received from the controller into a first ultrasound signal, and a first ultrasound receiver is positioned at a selected distance from the first ultrasound transmitter, wherein the butt-fusion transducer includes a first engagement surface, wherein the butt-fusion transducer is positionable in a use position in which the first engagement surface is engaged with at least one pipe from the first pair of pipes such that the first ultrasound transmitter is positioned to transmit the first ultrasound signals towards the butt-fusion joint and the first ultrasound receiver is positioned to receive a reflection of the first ultrasound signal from the butt-fusion joint and to transmit first receiver output to the controller via the first electrical connection; and an electro-fusion transducer that includes a third signal connector that is shaped to releasably connect to the first signal connector, so as to form a second electrical connection that permits signal transmission between the electro-fusion transducer and the processor, wherein the electro-fusion transducer further includes a second ultrasound transmitter that converts second electrical signals received from the controller into a second ultrasound signal, and a second ultrasound receiver, wherein the electro-fusion transducer includes a second engagement surface, wherein the electro-fusion transducer is positionable in a use position in which the second engagement surface is engaged with at least one pipe from the second pair of pipes such that the second ultrasound transmitter is positioned to transmit the second ultrasound signals towards the electro-fusion joint and the second ultrasound receiver is positioned to receive a reflection of the second ultrasound signal from the electro-fusion joint, and to transmit second receiver output to the controller via the second electrical connection. The controller is operable in a first mode when the second signal connector is connected to the first signal connector. In the first mode the controller is programmed to emit butt-fusion assessment output via the output device relating to a quality of the butt-fusion joint based on the execution of the instructions and the first receiver output. The controller is operable in a second mode when the third signal connector is connected to the first signal connector. In the second mode the controller is programmed to emit electro-fusion assessment output via the output device relating to a quality of the electro-fusion joint based on the execution of the instructions and the second receiver output.

Other technical advantages may become readily apparent to one of ordinary skill in the art after review of the following figures and description.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 depicts a cross-section of a BF joint in a PE pipe with an example wedge transducer thereon;

FIG. 2A depicts an example tandem transducer arrangement;

FIG. 2B depicts an example chord transducer arrangement;

FIG. 3A depicts a rear, top perspective view of an example transducer housing;

FIG. 3B depicts a rear, bottom perspective view of the example transducer housing shown in FIG. 3A;

FIG. 4 depicts a bottom view of the example transducer housing shown in FIG. 3A;

FIG. 5A depicts a front cross-sectional view of an example transducer housing showing transducers therein, atop a pipe shown in cross-section through a BF joint;

FIG. 5B depicts a top cross-sectional view of the example transducer housing shown in FIG. 5A, showing transducers therein, atop a pipe that is partially shown, and abutting a weld bead of a joint of the pipe;

FIG. 6 depicts a top perspective view of an example transducer housing atop a pipe shown in cross-section through a BF joint, and abutting a weld bead of the BF joint of the pipe;

FIG. 7A depicts an output from a digital oscilloscope of a signal reflected from a weld area of a PE pipe joint in the absence of defects;

FIG. 7B depicts an output from a digital oscilloscope of a signal reflected from a flat bottom hole in a PE pipe with diameter 5/16″;

FIG. 8A depicts a graph showing the amplitude of reflected signals as a function of defect diameter;

FIG. 8B depicts a graph showing amplitude of reflected signals as a function of position in wall thickness for a 7/32″ defect size;

FIG. 9 depicts a visual representation of dimensions throughout a convolutional autoencoder (CAE), with changes in dimension due to convolution (C), max pooling (P), or up-sampling (U) operations within the network;

FIG. 10 depicts pre-processed A-scans (black, dashed) with CAE reconstructions (gray, solid) from a flawless joint sample (top) and a flawed joint sample (bottom), with amplitudes charted in logarithmic scale;

FIG. 11 depicts true negative rate (TNR) and true positive rate (TPR) given k for an outlier threshold optimization process;

FIG. 12 depicts, on the left axis, histograms (dark gray depicts all flawless samples, light gray with angled markings depicts all flawed samples) and model probability density (black thick solid line) of reconstruction error (log scaled) for a single CAE example, on the right axis, cumulative distributions of reconstruction error for central (C), inner-diameter (ID), and outer-diameter (OD) flaws for 7/32″ void, aluminum, and soil samples, and further depicts an outlier threshold (dotted vertical line) at 0.000666, which has a cumulative density of 0.967 for flawless samples;

FIG. 13A depicts examples of A-scan signals received from each of four categories of BF joint types for 2″ diameter PE pipe;

FIG. 13B depicts schematic representations of types of pipe joints corresponding to the respective A-scan signals shown in FIG. 13A;

FIG. 14 depicts bootstrapped (1000 replicates), median (solid black line) and quantile ranges (solid grey areas) for preprocessed flawless, dirt-contaminated, CF60, and CF70 signals;

FIG. 15 depicts an example ultrasound system connected to an external device;

FIG. 16 depicts a schematic diagram of the example ultrasound system shown in FIG. 15, not connected to the external device;

FIG. 17 depicts an example method described herein;

FIG. 18 depicts an example GUI described herein;

FIG. 19 depicts another example GUI described herein;

FIG. 20 depicts yet another example GUI described herein;

FIG. 21A depicts a rear, bottom perspective view of an example electro-fusion transducer described herein;

FIG. 21B depicts a side view of the electro-fusion transducer shown in FIG. 21A;

FIG. 21C depicts a side view of the electro-fusion transducer shown in FIG. 21A, shown atop a pipe;

FIG. 22A depicts a perspective view of a pair of pipes joined by an electro-fusion joint; and

FIG. 22B depicts a cross-sectional side view of the pipes joined by the electro-fusion joint shown in FIG. 22A.

Unless otherwise specifically noted, articles depicted in the drawings are not necessarily drawn to scale.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although example embodiments are illustrated in the figures and described below, the principles of the present disclosure may be implemented using any number of techniques, whether currently known or not. The present disclosure should in no way be limited to the example implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “example” or “e.g.” should be understood as “illustrative” or “exemplifying” and not necessarily as “preferred” over other embodiments. Further definitions for terms may be set out herein; these may apply to prior and subsequent instances of those terms, as will be understood from a reading of the present description.

The indefinite article “a” is intended to not be limited to meaning “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Well-known methods, procedures and components have not been described herein in detail so as not to obscure the example embodiments described herein. Also, persons of skill in the art will appreciate that there are alternative implementations and modifications, beyond those of the example embodiments described herein, that are possible, and that the described embodiments are only for illustration of one or more example implementations. The description, therefore, is not to be considered as limiting scope, which is only limited by the claims appended hereto.

In order to address at least some of the drawbacks of current BF and EF PE pipe joint testing, the inventors tested a solution for real-time automated quality analysis or NDE, based on advanced ultrasonic NDE techniques with ability for fast and highly accurate interpretation of ultrasonic signals using deep learning (DL), machine learning (ML) and/or artificial intelligence (AI).

In a first aspect, a deep learning framework was applied for inspection of BF joints of PE pipes for gas and water applications, in support of an advanced ultrasonic transducer system, and to apply deep learning inference to numeric features of detected signals in real-time during ultrasonic inspection.

Another goal of this research was to demonstrate how the result obtained from the deep learning model can be used to understand the physical phenomena of wave propagation taking place inside materials within the joints, including interaction with various internal defects. It is crucial for inspection cycle time that this understanding is as precise as possible, and achieved in real time; high-speed, customized deep learning models allow the system to make immediate decisions while simultaneously saving the analyzed data, which could be used to train, or further train, the DL model. It is expected that the aspects described herein may achieve, or come close to achieving, zero-defect and first-time-right production of BF and EF joints in PE pipes, by allowing for relatively precise analysis and identification of different types of BF and EF joint defects in the field, and using that information to improve production of such joints, such as where the device(s) described herein comprise Internet of Things (IoT) devices capable of communicating with production machines and devices over, e.g., the Internet or a secure network.

Initial Test Samples

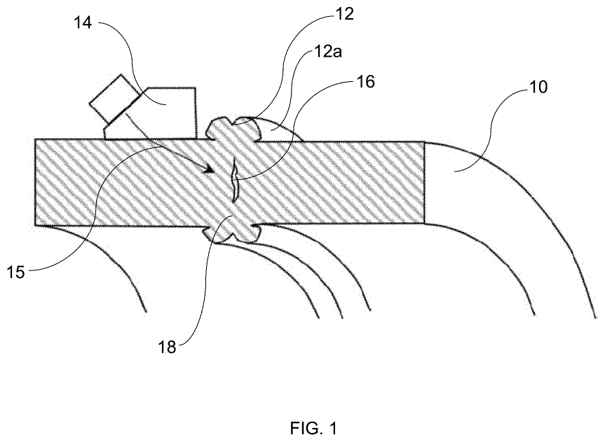

PE used for pipe production is characterized by relatively low longitudinal sound wave velocity (2200-2400 m/s) and high attenuation which quickly increases with frequency. Shear waves attenuate with a much higher coefficient. This limits practical usable ultrasound to longitudinal waves in the range of 1.5-3 MHz if the acoustical path needs to be several centimeters. With reference to FIG. 1, geometry of welds or joints 12 with a protruding bead 12a about a PE pipe 10 allows only side introduction of the ultrasound beam 15 from the transducer 14 through a wedge. Most of the flaws or defects 16 in PE pipe joints 12, which originate during BF joining or welding, or which may emerge during the joint's stress-intensive lifetime, are oriented in the plane 18 of the cross-section of the joint 12. As a result, ultrasound beams 15 do not reflect directly back to the transducer 14. Only edge diffraction waves or the side of the beam 15 produces a useful reflected signal (A-scan).

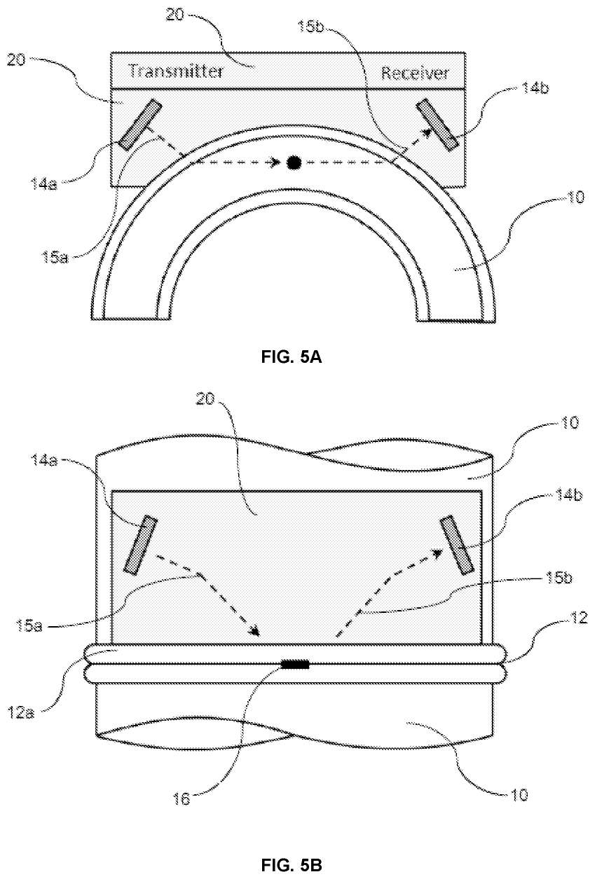

In BF joints, most of the defects 16 will be oriented in the plane 18 of the cross-section. Therefore, by using conventional pulse-echo or pitch-catch methods, ultrasound beams 15 do not reflect directly back to the transducer 14. The transducer wedge shown, e.g., in FIG. 1, can be used to inspect the cross-section of the joint 12 with the maximum beam energy, focusing on the joint center. Considering the geometry of the bead of the weld 12, only the side introduction of the ultrasound beam 15 through the transducer wedge 14 is possible. The transducer wedge 14 is capable of holding transducers at a specific angle that focuses the maximum energy of the wave to the center of the weld plane 18. In the presence of the planar or volumetric defect 16, the signal is reflected back to the receiver 14b from the defect 16. The material from which the body 20 of the transducer wedge 14 is made may, in some aspects, be the same as the pipe material, thereby introducing no diffraction when a wave travels from the transducer wedge 14 medium to the pipe 10 being inspected. Both the emitter and receiver crystals may be perfectly aligned and placed in one portion of the transducer wedge 14 at a specific distance (see, e.g., FIG. 5). This geometry stimulates the use of more complex pitch-catch arrangements with a separate receiving transducer (or ultrasound signal receiver) 14b, positioned on the way of the expected reflected beam. The position of the probes 14a, 14b and geometry of the transducer wedge 14, 20 is optimized for each particular pipe diameter and wall thickness.

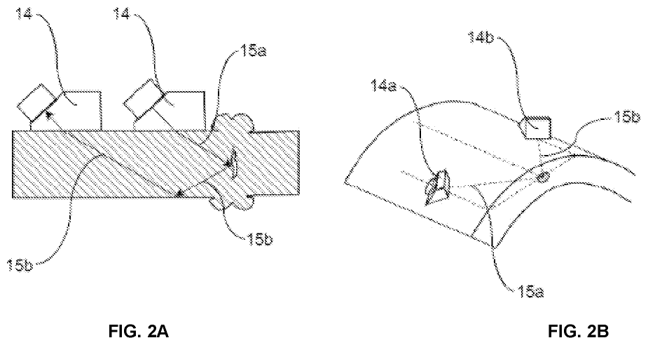

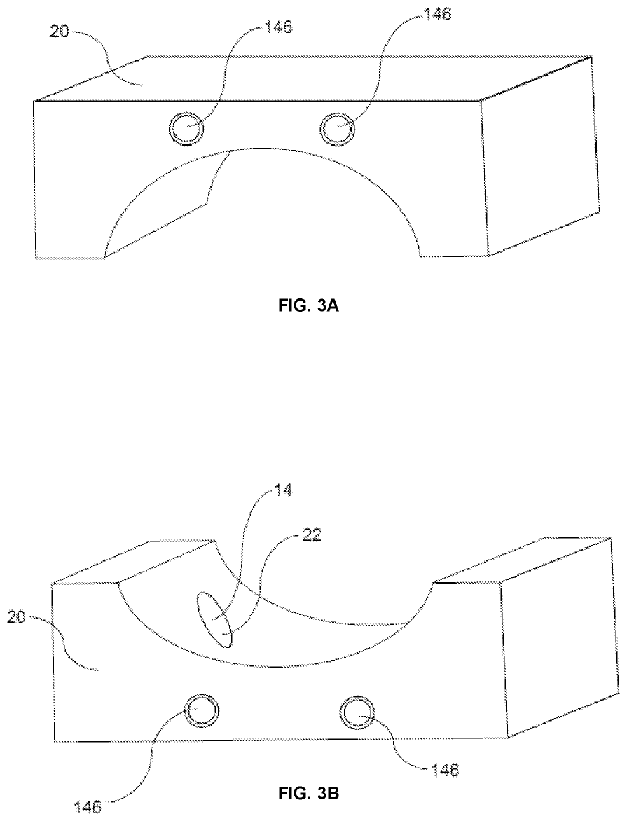

With reference to FIG. 2A and 2B, two geometries could be used to address this issue: a “tandem” setup (shown in FIG. 2A) with additional reflection from the inner side of the pipe 10, and a chord setup (shown in FIG. 2B). The “tandem” setup has a suitable sensitivity for defects in the middle of the wall thickness but areas close to the outer surface are difficult to inspect. Thus, the inventors focused on chord-type transducers 14, designed for detection of transversal flaws in joints 12 of PE pipes 10. The relative position and orientation of the transmitting transducer or ultrasound signal transmitter 14a and the receiving transducer or ultrasound signal receiver 14b (each emitting an emitted ultrasound signal 15a, and detecting a reflected ultrasound signal 15b, respectively) of the transducer 14, were optimized for each particular pipe 10 diameter and wall thickness. With reference to FIGS. 3A and 3B, in some aspects, for convenience of operation and/or increased durability for in-field use, the ultrasound signal transmitter (or transmitting transducer) 14a and the ultrasound signal receiver (or receiving transducer 14b) may both be encased in a transducer housing 20 that is shaped to accommodate a cylindrical pipe geometry of the pipe 10, such that the transducer 14 can be moved about a circumference of the pipe 10 while maintaining contact with the pipe 10 across an engagement surface 22 of the transducer 14 (14a, 14b) that is selected to permit pass-through of the ultrasound signal 15a and the reflection of the ultrasound signal 15b. By such chord arrangement, the thickness of the weld may be covered by one position of the transducer pair 14a, 14b, housed within a single transducer housing 20. The transducer housing 20 may, e.g., comprise a wedge of monolithic diameter-specific molding. In some aspects, the molding 20 may comprise a soft material with a flexibility that accommodates small deviations in pipe diameter and shape distortions, in order to provide good contact between the engagement surface(s) 22 of the transducer 14 and the pipe 10. As used herein, “transducer 14” may, in some aspects, mean both the ultrasound signal transmitter (or transmitting transducer) 14a and the ultrasound signal receiver (or receiving transducer 14b) operating together within a single transducer housing 20.

The transducers 14 in the experimental setup were connected to a standard flaw detector with signal registration on a digital oscilloscope. BF joint samples were fabricated to conduct experimental work, and for the purpose of DL/AI/ML training. Medium-density polyethylene (MDPE) pipes with outer diameters of 2″, 3″, 4″, 6″, and 8″ were welded using a regular hydraulic heat fusion welding machine. The set of pipes included several samples without any flaws (acceptable quality) and samples containing artificially introduced planar defects. The introduced defects simulated prevalent defect types: solid inclusions, air-filled voids (cracks), soil contamination, and cold welds. The position and presence of defects was confirmed by 5 MHz phased array inspection. A test piece with a flat-bottom drilled hole (standard for such measurements) was used for system calibration.

Solid inclusions with acoustic impedance higher than PE were imitated by embedding metal bead targets made from 0.005″ aluminum sheet into the weld line. These targets had diameters 5/32″, 7/32″, and 5/16″, close to 30%, 40%, and 60% respectively of wall thickness for 6″ pipe 10. Their placement into mid-thickness of the pipe wall presented certain challenges as the motion of melted pipe material during heating and squeeze could shift targets from their initial positions. For statistical measurements, the inventors used targets in the form of stripes with corresponding widths, as their placement across wall thickness was easier to replicate. Comparisons of acoustical reflectivity of circular targets and stripe targets performed on small test pieces in the normal pulse-echo setup showed approximately 2× greater amplitude for stripe reflectors of equivalent width.

Air-filled voids were fabricated by two different methods. In the first case, flat-bottom holes were drilled from the pipe end. Their diameters were chosen from the same line 5/32″, 7/32″, and 5/16″. Beside the mid-wall position, some drilled holes were made at ⅓ of the wall thickness near outer or inner surfaces of the pipe 10. The second variant included insertion of paper napkin strips in the middle of weld seams. Simple drilling into the pipe end as in the first case did not give satisfactory results with good consistency; the reflective surface of the final void often shifted away from the welding line and its flatness was disrupted due to flow of melted PE into the drilled hole. Nevertheless, they were also included in the DL/Al/ML training pool.

Soil contamination was modeled by sticking a small amount of sand onto the melted surface before joining. The size of the resultant flaw could only be estimated due to uncontrollable augmentation. The cold weld samples were fabricated by spraying water on some areas of the melted pipe end causing local cooling of the surface. The size and properties of flaws created in this manner varied from one sample to another, so they were used for qualitative estimations only.

Results of Initial Ultrasonic Measurements

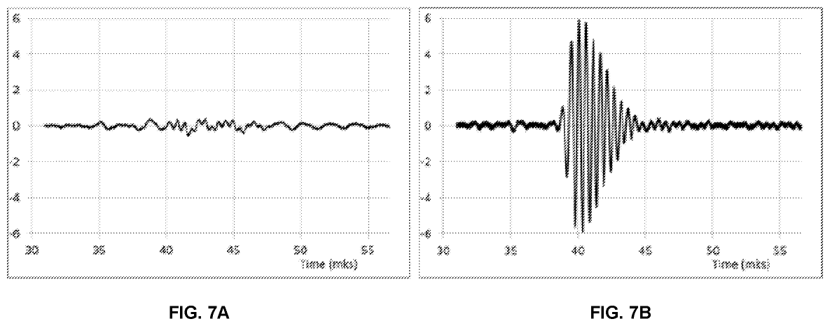

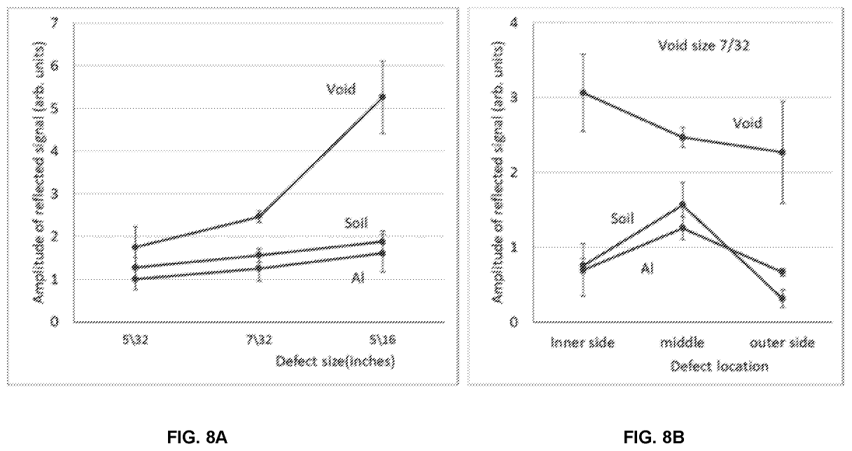

Chord-type transducers 14 placed on the pipe 10 away from the weld 12 did not produce a noticeable signal. However, in the working position (close to or abutting the weld bead) the resultant A-scan contained some oscillations originating from reflections between bead shoulders. The exact shape of the signal depended on bead shape and magnitude. In some adverse cases, the reflection overlapped with the signal from a defect. Low frequency ringing present on the A-scan (FIG. 7A) could be filtered out, with the remaining amplitude coming from the real reflection. For comparison, FIG. 7B shows a signal obtained from a 5/16″ flat-bottom hole; it demonstrates the case of a clear and obvious void detection. The amplitude of the reflected signal increased with defect size (FIGS. 8A and 8B). In FIGS. 8A and 8B, each point represents the average of multiple measurements (N>50) on three different samples. There are noticeable differences in amplitudes between flat bottom holes and same-size aluminum inclusions, which were expected to be coming from partial transparency and misorientation of thin aluminum discs in melted PE. The shape of the reflected pulse envelope varied from one measurement to another, but distinctive wave propagation patterns were expected from each type of defect, and it was further expected that application of deep learning would reveal these differences.

The data shown in FIGS. 8A and 8B proved the inventors' assumption that reflected signals, coming from the internal defects, represent character and size of the defects. It also demonstrated that the chord-type transducer 14 method produces signals with the same amplitude (within an acceptable margin of error) for defects positioned differently across the wall thickness. Examples of an acceptable margin of error vary depending on many factors that will be apparent to on skilled in the art. In some instances, for example, a 5% margin of error may be acceptable. In other instances a 1% margin of error may be acceptable. Other margins of error that differ from these example numbers may be applicable in certain situations. The acceptability of the joint 12 where ultrasonic inspection revealed the presence of sound reflection was to be determined by corresponding national industry standards. In ultrasound procedures, there is a practice to compare obtained A-scans with reference signals acquired in the same conditions from calibration samples. The joint 12 was considered unacceptable if the amplitude of the reflected signal in any region along the weld 12 rose above a certain threshold. This threshold was set according to a signal obtained on the calibration sample (e.g., a piece of PE pipe with a flat-bottom hole of a certain diameter). The weld 12 was considered good or acceptable if the amplitude of the reflected signal remained less than −6 dB from the threshold. In between these two cases was a “gray zone” where the decision as to acceptability came from practice and experience of the operator. This approach was similar to the “green-yellow-red” ideology, accepted in some other NDE areas.

Artificial Intelligence used for Initial Training

Machine learning is a field of AI in which computational models are trained to conduct tasks automatically through experience with data. Deep learning is a type of machine learning that specifically uses deep artificial neural networks and has shown excellent performance in a variety of tasks. Machine learning can be broadly categorized into supervised learning and unsupervised learning, the former requiring both input and target output vectors to be provided to the ML model during training while the latter only requires input vectors without target outputs. Supervised learning can be further subdivided into classification and regression, while unsupervised learning typically involves clustering or representation learning. Flaw detection is often framed as classification or object detection when labeled data are cheap and easy to obtain for all the required classes. However, deep learning models are notorious for requiring immense amounts of data. In supervised learning, the issue is exacerbated as data labeling can often be one of the most expensive and time-consuming processes in machine learning. In the context of flaw detection, it is often difficult to reliably simulate the various types of flaws that are observed in the production environment. Thus, in such situations, unsupervised deep learning approaches are often useful.

Autoencoders (AEs) are deep learning architectures that learn representations of their input data using an unsupervised approach. Specifically, an AE can be subdivided into an encoder and a decoder. The encoder is responsible for learning some latent representation (the “code”) of the input data, while the decoder is responsible for transforming this code back into the original input as well as possible. Thus, a basic AE's task is to learn an approximate identity function such that its output is approximately equivalent to its input. However, various constraints are often applied to the AE (such as limits to the size of its latent representations, sparsity constraints, or prior assumptions on the distributions of latent variables), such that the task becomes non-trivial. Intuitively, despite these constraints, if an AE can learn a latent representation of its input and subsequently reconstruct its input reasonably well from the latent representation, then the AE must have learned to extract information-rich and relevant features from its input.

Standard autoencoders are usually created by stacking fully-connected neural network layers that generally repeatedly reduce the size of the representation to a bottleneck on the encoding half, and then increase the size of the representation back to the input size on the decoding half. Such AEs are less suitable for data which have inherent spatial or temporal relationships (such as signals or images). Instead, a similar approach, of encoding the input to a bottleneck representation and then decoding it, can be taken but instead using convolutional layers, which allows the network to leverage the spatial or temporal relationships within the data by learning filters with which to convolve over the signal or image and its intermediate representations. Such an architecture is called a convolutional autoencoder (CAE).

The basic performance measure of an AE is reconstruction error—a measure of similarity between its input and its output. Often, mean squared error (MSE) is used for reconstruction error, though other performance measures can be used as well. A well-trained AE will reconstruct samples like its training input reasonably well, i.e., it will produce an output having low reconstruction error, because it has learned features and representations of its training data. Similarly, an AE will typically create increasingly poor reconstructions, i.e., having increasing reconstruction error, of samples that increasingly differ from its training input. Thus, AEs have seen extensive use in flaw detection, framing it as an outlier detection problem rather than a classification problem, because AE reconstruction error, deviance from latent prior distributions, or even deviance from typical projection pathways can be used as reliable measures of sample outlierness. Importantly, framing the problem of flaw detection as outlier detection using an AE can be advantageous to other approaches (e.g., classification, object detection) because the AE approach only needs a large amount of flawless samples (usually easier and cheaper to mass-produce than flawed samples) whereas other approaches usually require copious amounts of both flawless and flawed samples which are labeled as such. Further, classification and object detection approaches do not typically fare well in identifying novel or unseen defects on which they were not trained.

The inventors trained CAEs to recognize A-scans from flawless BF joint samples, and subsequently evaluated their suitability for flaw detection using an outlier detection approach.

Convolutional Autoencoder Development and Evaluation during Initial Training

To detect flaws, an outlier detection approach was used, using MSE (the autoencoder reconstruction error) as an outlier score, and a CAE. The suitability of the CAE-based flaw detection approach was evaluated using only the 6″ pipe samples due to sample availability; however, based on the observed A-scans for other pipe dimensions, the inventors believe that this approach would extend to all common pipe dimensions in the infrastructure industry. With the CAE-based outlier detection approach, only A-scans from flawless joints were needed to train the model while a combination of A-scans from flawless and a variety of flawed pipe joints were used to calibrate the outlier cutoff for reconstruction error and to validate the approach.

Flaws were visible on the oscilloscope with the device positioned near the flaw and within 2″ of the pipe joint 12. A total of 4,200 A-scans were obtained from seven flawless BF 6″ pipe joints with the transducer 14 placed in random positions within 2″ of the joint 12 (300 per side of joint, or 600 per pipe joint 12). From these A-scans, four partitions were developed: CAE training (50% of A-scans), CAE validation (10%), outlier threshold optimization (30%), and outlier threshold testing (10%). A dataset of A-scans was also obtained for the variety of defects described above (see Table 1, below), and two partitions were made for each defect subtype: outlier threshold optimization (75% of A-scans) and outlier threshold testing (25% of A-scans).

TABLE 1
Dataset of A-scans from defective pipe joints

| Defect Type | Defect Subtype | Number of A-scans |
|---|---|---|
| Void (drilled) | 5/16″, 5/32″, 7/32″ C, | 100 per defect |
| | 7/32″ ID, 7/32″ OD | subtype, 700 total |
| Void (napkin) | Single napkin inclusion | 800 total |
| Soil | 5/16″, 5.32″, 7/32″ C, | 100 per defect |
| | 7/32″ ID, 7/32″ OD | subtype, 700 total |
| Aluminum | 5/16″, 5/32″, 7/32″ C, | 100 per defect |
| | 7/32″ ID, 7/32″ OD | subtype, 700 total |

For each defect type, the corresponding subtypes were produced: C=centered defect within the pipe wall, ID=defect is in the inner diameter of the pipe wall, and OD=defect is in the outer diameter of the pipe wall.

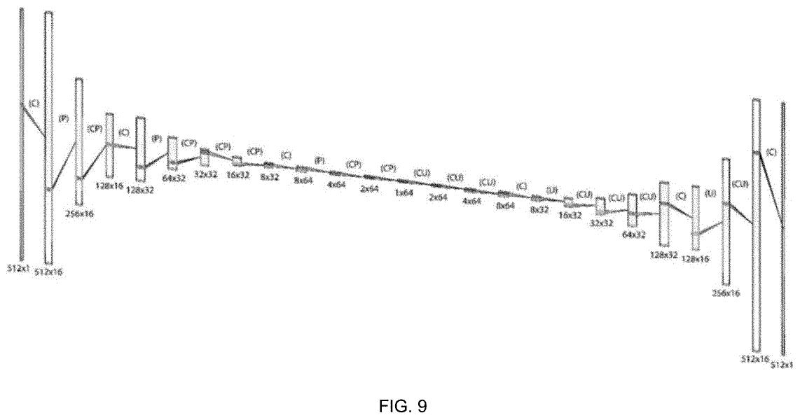

Ten replicates of Monte Carlo cross-validation were then conducted, i.e., for each replicate the aforementioned partitions were randomly developed. For each replicate, a CAE was trained (see FIG. 9) using the CAE training partition with a fixed set of hyperparameters and signal preprocessing methodology, which was found to be good through prior experimentation. Signal pre-processing involved applying a high pass filter with a cutoff of 1.5 MHz, resampling the signal to 512 elements, and then computing the Hilbert envelope. The CAE validation partition was used to validate the CAE (i.e., to ensure that overfitting to the training data did not occur). After training the CAE, the outlier threshold was optimized using the outlier threshold optimization A-scan partitions from both flawless and flawed samples. The first step of this optimization process involved pushing each of the A-scans through the CAE and computing the reconstruction error (MSE) for each A-scan.

The mean (m) and standard deviation (S) of MSE for all A-scans in the outlier threshold optimization partition from flawless joints was computed. Then, a grid search of threshold t=m+kS was conducted for k=1, 1.25, 1.5, 1.75, 2, 2.25, 2.5, 2.75, and 3.

Mean and standard deviation of true negative rate (TNR) and true positive rate (TPR) was measured for the outlier threshold optimization partitions across all ten replicates to assess performance. The value k was selected such that the mean TNR was at least 0.95, and if both mean TPR and TNR were >0.95, k was selected such that their difference was minimized. The outlier threshold testing partitions from both flawless and flawed samples were then used to evaluate the full model.

A wide variety of CAE hyperparameters and A-scan preprocessing methods were tested. What was found by the inventors to be the best combination will now be described. The inventors found their approach to be very robust to CAE hyperparameters and A-scan preprocessing methods. The CAE presented here had 19 convolution layers, each with padding to retain the height of the representation. All filters were of size 3. All convolution layers had no bias, followed by batch normalization (BN), followed by activation through rectified linear unit (ReLU). The only exception was the final layer, which used a bias and linear activation without BN. To reduce the height of the representation in the encoding half, max pooling was used after each activation layer. Analogously, in the decoding half, up-sampling was used after each activation layer. The CAEs for 400 epochs were trained with a batch size of 64 using the Adadelta optimizer in Keras™ with the TensorFlow™ backend, on an Nvidia™ GeForce RTX 2080ti™ graphics processing unit (GPU).

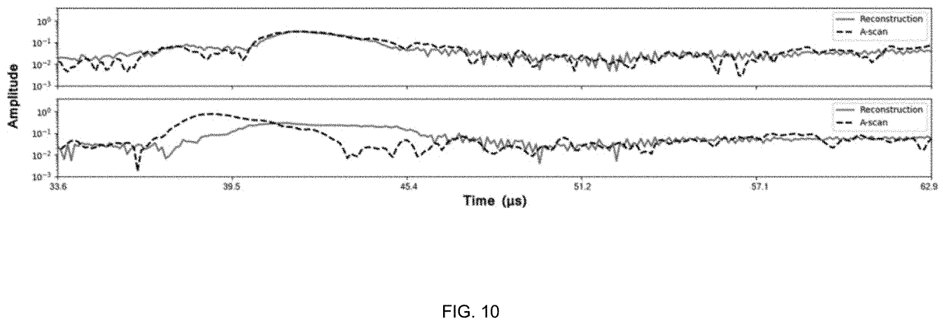

The CAEs were able to accurately reconstruct A-scans from the flawless samples. Further, the CAEs reconstructed A-scans from flawless samples much better than those from various flawed samples (see FIG. 10, in which the flawed sample shows greater discrepancy between A-scan and reconstruction). The CAEs were trained only on A-scans from flawless joints, and thus they were able to reconstruct them accurately. As the CAEs were not trained on A-scans from flawed joints, the CAEs produced poorer reconstructions of them. This disparity formed the basis of the inventors' CAE-based flaw detection approach.

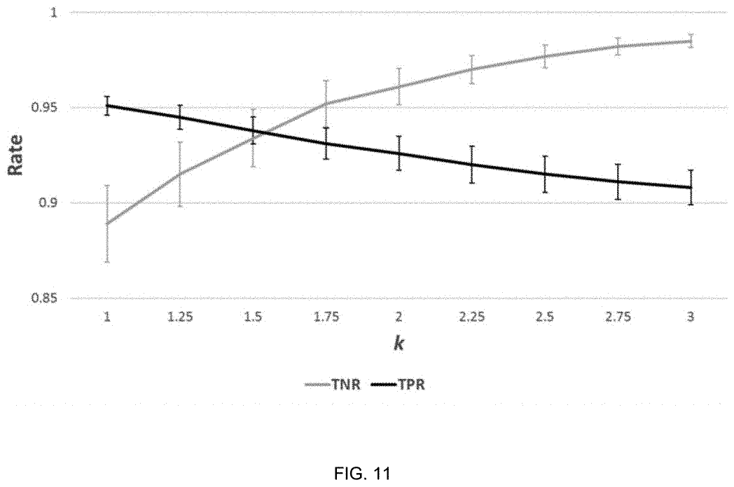

Outlier threshold optimization yielded an optimal k of 1.75 (see FIG. 11; k was selected to be k=1.75, as it produced a TNR>0.95 and minimized the disparity between TNR and TPR). As such, the k parameter was fixed and the flaw detection pipeline was tested using the outlier threshold testing partitions. With the CAE-based approach, the inventors were able to detect flaws with a TPR of 0.930 while retaining a TNR of 0.940. The approach yielded very strong detectability for most defect subtypes (see Table 2, below). In particular, all A-scans for void, napkin, and cold water were detected in all ten replicates.

TABLE 2
Detection rate per defect subtype.

| | Mean Detection Rate | |
|---|---|---|
| Defect Subtype | (Standard Dev.) | |
| Void 5/16″ | 1.0 | (0) |
| Void 5/32″ | 1.0 | (0) |
| Void 7/32″ C | 1.0 | (0) |
| Void 7/32″ ID | 1.0 | (0) |
| Void 7/32″ OD | 1.0 | (0) |
| Aluminum 5/16″ | 1.0 | (0) |
| Aluminum 5/32″ | 0.894 | (0.085) |
| Aluminum 7/32″ C | 1.0 | (0) |
| Aluminum 7/32″ ID | 0.535 | (0.225) |
| Aluminum 7/32″ OD | 0.605 | (0.138) |
| Soil 5/16″ | 1.0 | (0) |
| Soil 5/32″ | 1.0 | (0) |
| Soil 7/32″ C | 1.0 | (0) |
| Soil 7/32″ ID | 0.854 | (0.047) |
| Soil 7/32″ OD | 0.009 | (0.018) |
| Single Napkin inclusion | 1.0 | (0) |

Most subtypes of aluminum contamination were detected easily (>0.9 TPR), however there was a relationship between contaminant size and detectability. Also, outer diameter defects were less detectable (0.605±0.138 TPR) than central defects (1.0±0 TPR), and inner diameter defects were even less detectable (0.535±0.225 TPR). For soil contamination, a similar relationship was observed but inner diameter defects (0.854±0.047 TPR) were less detectable than central defects (0.992±0.016 TPR), and outer diameter defects were rarely detectable (0.0091±0.018 TPR).

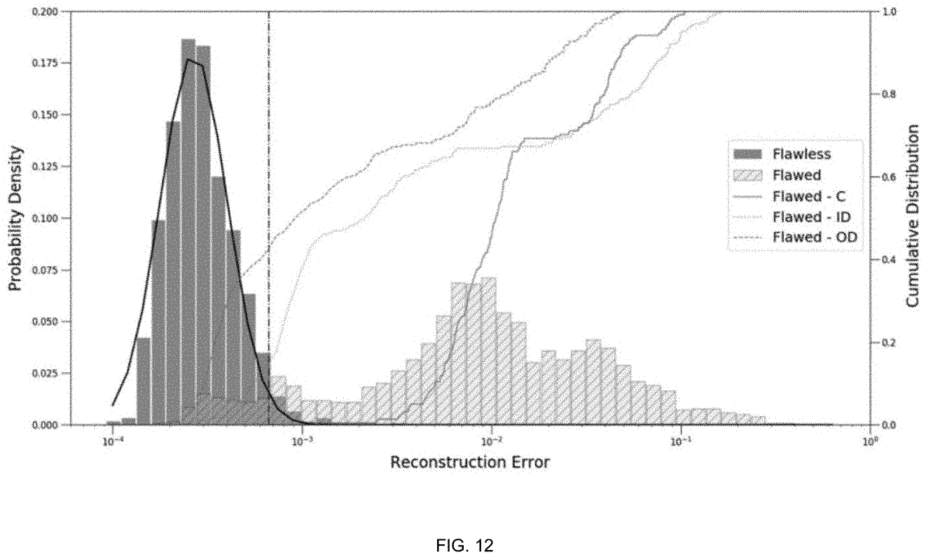

In the production environment, output from the inventors' system indicating “flawless”/“flawed” would be valuable to the user in identifying flawed regions of the BF joint. However, on its own, it would be difficult to localize the joint flaws 16 when attempting repairs, as the user would not know where the defect is located, until they happen to come across it. Thus, in addition to the descriptive (“flawless”/“flawed”) output, a numerical score indicating A-scan outlierness would provide the user with greater resolution, interpretability, and the ability to localize joint defects 16. While ten flaw detection models were trained and validated, the single best model was selected and transferred into a portable device (described below) as the AI inference module. While the raw reconstruction error values of each A-scan as this numerical output could be used, on its own it is difficult to interpret, and so the cumulative density of reconstruction error was used as the numerical outlierness score, which gives a numerical score between 0 (not at all an outlier) and 1 (very likely an outlier). To this end, the inventors modeled the distributions of reconstruction error of flawless A-scans for each CAE using a lognormal distribution (example FIG. 12, top). Subsequently, the distribution model can be queried with the reconstruction error for a given A-scan to obtain its corresponding cumulative density. In the given example, the selected reconstruction error threshold was 0.000666, which amounts to a cumulative density of 0.967. Thus, as the user is operating the system, they can conduct local searches around the pipe joint 12 to try to find regions that maximize the cumulative density output. For this example, if the local search yields A-scans with reconstruction error <0.000666 (i.e., cumulative density <0.967), then the region is flawless and the user can look elsewhere. Otherwise, if the user finds a region with A-scans having reconstruction error ≥0.000666 (i.e., cumulative density ≥0.967), then the user has very likely found a defective region on the pipe joint 12.

Signals from central flaws generally had greater amplitude and other ultrasonic characteristics (e.g., position of amplitude peaks, etc.) that more strongly distinguished them from flawless samples, while inner- and outer-diameter flaws (and flaws of smaller magnitude) yielded signals that were generally more similar to flawless samples. As mentioned above, this approach yielded strong overall detection rates for the tested flaws, but performed poorer on inner-diameter and outer-diameter flaws compared to central flaws (e.g., FIG. 12, bottom; note how little of the flawed histogram is below threshold, and that inner-/outer-diameter flaws exhibited earlier increase in CDF than central flaws, and outer-diameter flaws are especially difficult to detect) as well as flaws of smaller magnitude. This was an anticipated result because the CAE learns filters that are conducive to reconstruction of flawless samples, and these filters should therefore allow better reconstruction of signals that have ultrasonic characteristics similar to those of the flawless samples.

The results demonstrated the applicability of a chord-type ultrasonic non-destructive inspection system, with a CAE-based inference system for detection of flaws 16 in BF welds or joints 12 of PE pipes 10. The CAE-based inference approach is valuable in the infrastructure industry for identifying regions of BF joints having a wide variety of defects. The ability of the system to compute an outlierness score may be valuable in localizing the defects as the user will observe changes in the outlierness score and move the device to attempt to maximize it. Using the data collected, the inventors aimed to develop a system that will not only aid in defect 16 localization but also classify them according to size (i.e., in inches), type (i.e., coarse contaminant, fine contaminant, void, cold fusion, crack, etc.), and location (central, inside diameter (ID), or outside diameter (OD)), for both BF and EF joints, which would be valuable to the industry in that it would provide users with automated inference on ultrasonic A-scans of BF and EF joints in light of current standards which are specific in terms of defect type, size, and location. The presently described aspects are expected to be able to automatically detect defective areas of the joints 12 and can be integrated into a simple, cost-effective, compact, and easy-to-use inspection system or device for in-field inspection of PE BF and/or EF pipe joints 12. It would allow NDE specialists to improve existing service and to provide automated high accuracy classification of the quality of BF and EF joints that matches with production-level satisfaction. It is expected that such a system or device may result in savings in production cycle time, cut labor costs, and eliminate unnecessary destructive tests which are today still a part of the quality inspection process.

Subsequent Testing and DL/ML/AI Training

Subsequently to the above initial testing and training, the inventors used the chord transducer 14, within the housing 20, on pipes 10 of various sizes, and these signals were analyzed and subsequently used to train a variety of classical ML (k-nearest neighbors (KNN), decision tree (DT), random forest (RF), support vector machine (SVM)) and DL (fully convolutional neural network (FCNN), convolutional neural network (CNN), long short-term memory (LSTM), bidirectional LSTM-BiLSTM) models for comparison in terms of suitability for the task of ultrasonic A-scan signal classification. DL/AI/ML training was conducted with respect to seven categories: 1) flawless or acceptable joints 12; 2) joints 12 comprising a void; 3) joints 12 comprising dust; 4) joints 12 comprising dirt; 5) joints 12 comprising grass; 6) joints 12 comprising a minor cold fusion flaw; and 7) joints 12 comprising a severe cold fusion flaw (see Table 3, below, showing the number of signals 15 tested on each of the categories above (with some of the categories being grouped) for each of three pipe sizes).

TABLE 3
Number of A-scans per defective pipe joint type per pipe size

| Pipe size | 2″ | 4″ | 6″ |
|---|---|---|---|
| Acceptable | 25 pipes | 8 pipes | 4 pipes |
| Joints | 100 signals | 200 signals | 200 signals |
| | of each | of each | of each |
| Void | 2 pipes | 2 pipes | 0 pipes |
| | 100 signals | 200 signals | |
| | of each | of each | |
| Contamination | 17 pipes | 8 pipes | 4 pipes |
| (dust, dirt, | 100 signals | 200 signals | 200 signals |
| and grass) | of each | of each | of each |
| Cold fusion | 20 pipes | 8 pipes | 2 pipes |
| (Severe and | 100 signals | 200 signals | 200 signals |
| Minor) | of each | of each | of each |

AI inference was conducted on each individual A-scan received from a given pipe joint 12. The outputs of the AI from each individual A-scan were used to comprehensively judge the quality of a joint. With respect to the AI, a deep-learning approach, convolutional neural networks (CNN), was employed since it was found to perform the best of all tested approaches. The inventors computed binary F1 (the F1 score considering a two-class problem, i.e., flawless joint vs. all defect types). This was computed only as a performance indicator on the four-class model shown in Table 3 (i.e., binary classifiers were not explicitly trained). The inventors found that Convolutional Neural Network (CNN) was the most performant in nearly all performance measures compared. Of the DL approaches, CNN outperformed the rest, and CNN was most performant according to the mean F1 score. Considering a binary classification problem using the same models, the CNN was again the most performant by binary F1 score.

It was found that the CNN was able to make the best use of subtle differences in signal shape, and was generally able to successfully identify flawless joints, as well as detect defects in pipe joints 12 and classify them according to type, and so CNN was overall the most performant modeling approach tested. In general, the models trained for the four-class problem generally performed strongly in the binary classification task, and it is expected that this training approach can extend to any classification problem formulation for automatically assessing PE pipe BF and/or EF joints. While the binary classification scenario was tested, the models were not trained specifically for this task; it is expected that models specifically trained for binary classification (or other specific alternative classification scenarios) should exhibit better performance than that of the inventors' in such alternative classification scenarios. This especially has implications should the classification task need to be altered, based on the results of destructive testing, which may determine that minor cold fusion joints 12 that are “CF60” are in fact acceptable joints 12 by current standards, for example.

Further DL/AI/ML training was conducted using a larger data set, as shown below in Table 4.

TABLE 4
Data acquisition for AI training

| | | # of | | # of | |
|---|---|---|---|---|---|
| | | Joint | #of | Joint | #of |
| Joint | | Sam- | A-scans | Samp- | A-scans |
| Condition | Description | ples 2″ | 2″ | les 4″ | 4″ |
| Flawless/ | No defect inside | 20 | 2000 | 8 | 1600 |
| Acceptable | the joints | | | | |
| Minor CF | 60 sec extra heat | 10 | 1000 | 3 | 800 |
| | plate removal time | | | | |
| Severe CF | Increased pressure | 10 | 1000 | 3 | 800 |
| | during heat cycle | | | | |
| | plus 70 second | | | | |
| | extra heat plate | | | | |
| | removal time | | | | |
| Contamina- | Dirt contamination | 10 | 1000 | 3 | 800 |
| tion | was applied inside | | | | |
| | the joint before | | | | |
| | heating the surface | | | | |

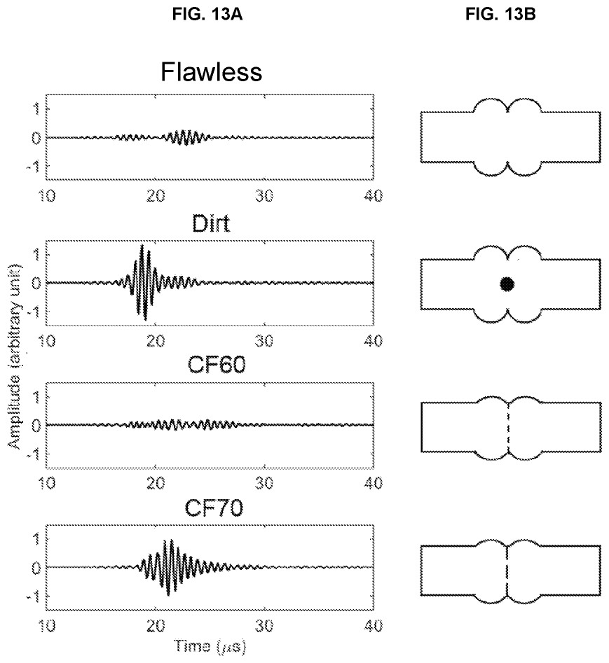

FIG. 13A shows examples of A-scan signals received from each of the four categories above for a 2″ diameter PE pipe 10, and FIG. 13B shows schematic representations of types of pipe joints 12 corresponding to the respective A-scan signals shown in FIG. 13A, with “CF60” being “minor cold fusion (CF)” (i.e., a cold fusion caused by the pipe ends in the BF joint 12 being left to cool down for 60 seconds prior to abutment therebetween), and “CF70” being “sever cold fusion (CF)” (i.e., a cold fusion caused by the pipe ends in the BF joint 12 being left to cool down for 70 seconds prior to abutment therebetween).

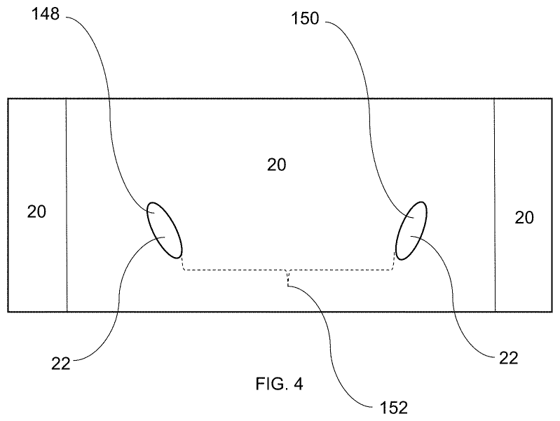

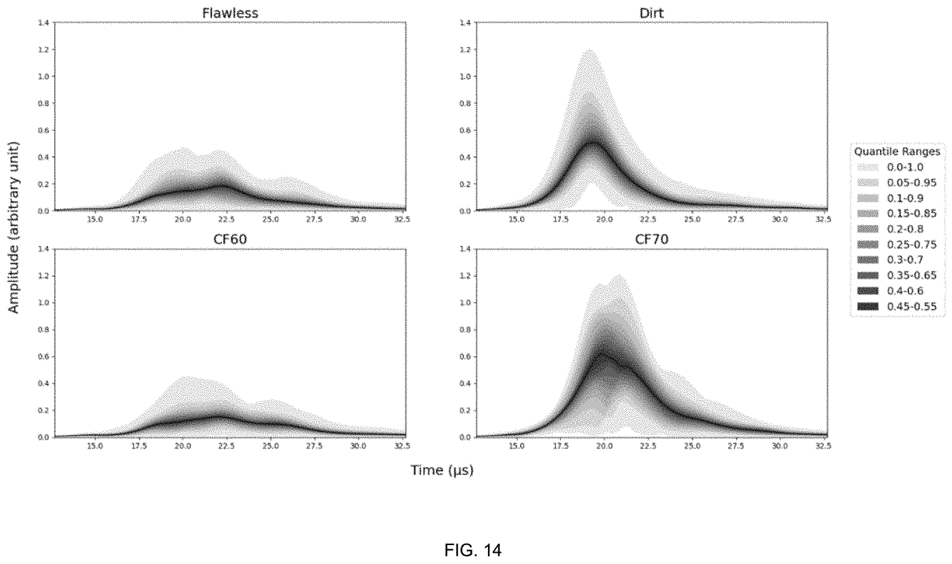

The two research avenues pursued were: 1) A-scan outlier detection using convolutional autoencoder, in which signal acquisition, for the data set shown in Table 3, was via an oscilloscope, and the results were not classified by the four joint types, but rather according to a binary classification: acceptable quality or unacceptable quality; and 2) A-scan classification using convolutional neural network (CNN), in which pipe joint defect classification was for all types shown in Table 4 (although Table 4 shows four groups or classifications under the “Joint Condition” column, in fact seven types of joints 12 were used to train the ML/CNN algorithm, and Table 4 groups the types of dust contamination, dirt contamination and grass contamination into a single “Contamination” category), using many more A-scan signals in the training data set (as also shown in Table 4), for 2″ and 4″ pipes, and further to the data shown in Table 4, further training of the ML/CNN algorithm was conducted for each of the seven categories above, as follows: for BF joints 12, 600 signals were acquired for each of the seven categories above for each of 2″, 4″ and 6″ pipes 10; and for EF joints 12, 600 signals were acquired for each of the seven categories above for each of 2″, 4″ and 6″ pipes 10. FIG. 14 depicts bootstrapped (1000 replicates), median (solid black line) and quantile ranges (solid grey areas) for preprocessed flawless, dirt-contaminated, CF60, and CF70 signals. While the flawless and CF60 graphs of FIG. 14 may be difficult for a user to differentiate upon visual inspection, it was found that the DL/AI/ML algorithm (i.e., CNN) trained according to the data shown in FIG. 4 was able to accurately identify the joints 12 containing the CF60 defects 16.

While the outlier detection approach has the advantages of a simple binary output that is easy for a user to interpret in the field, and requiring less data for the DL/AI/ML algorithm training, it suffers from the drawbacks of not identifying the specific types of defects detected, which makes it difficult for users to interpret the results in view of prevailing industry standards. The CNN approach, while requiring more data across all defect types of interest to train the CNN algorithm, provides defect-specific output that aligns better with industry standards, and is more useful for root cause analyses without the added time and expense of destructive testing to determine the specific types of defects present.

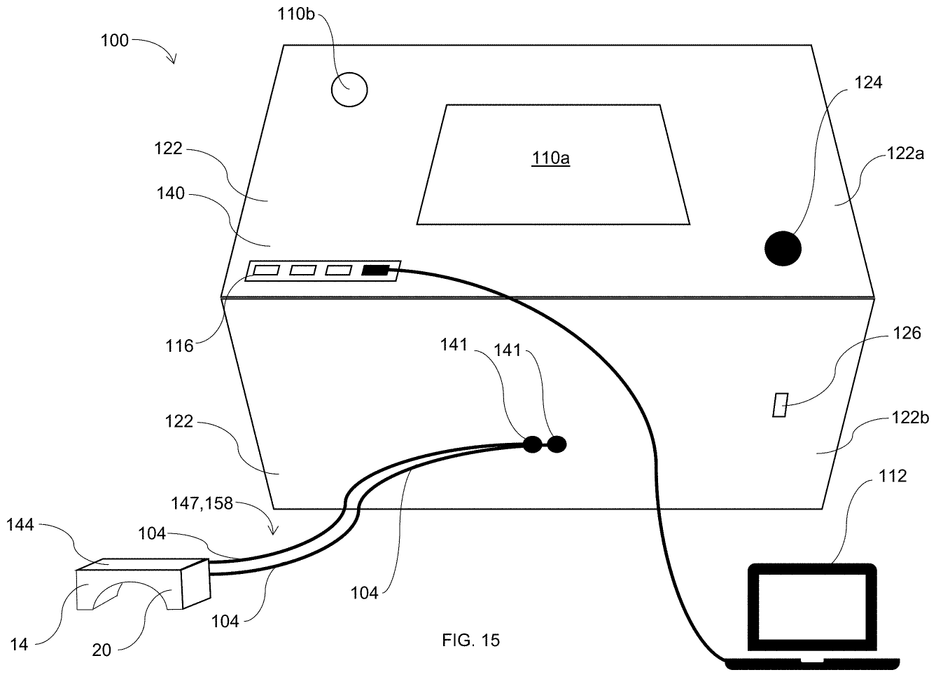

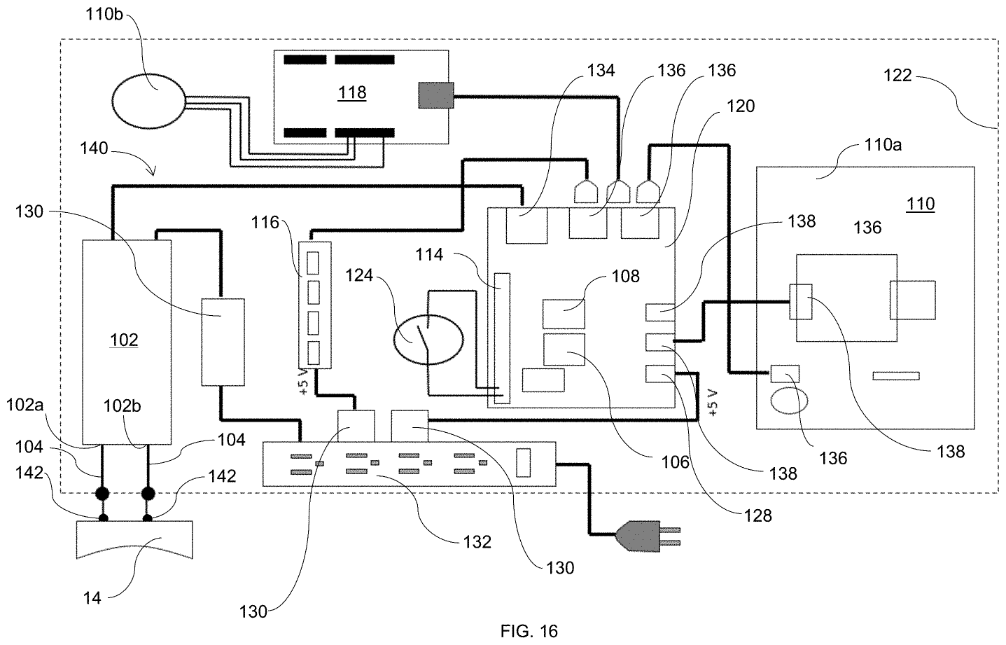

With reference to FIGS. 15 and 16, in some aspects an ultrasound system 100 for non-destructive evaluation (NDE) of a to-be-evaluated joint 12 between a pair of pipes 10 (the to-be-evaluated joint 12 being one of a butt-fusion (BF) joint 12 and an electro-fusion (EF) joint 12) may comprise: an ultrasonic unit 102 (such as an A1560 Sonic-HF™ ultrasonic pulser-receiver unit); a transducer 14 communicatively coupled to the ultrasonic unit 102 and operable remotely from the ultrasonic unit 102 (such as by wired or cabled connection between the transducer 14 and the ultrasonic unit 102, via electrically conductive cables 104). The transducer 14 converts electrical to ultrasound signals and vice versa, and may include (i) an ultrasound signal transmitter or transmitting transducer 14a positionable to transmit the ultrasound signal 15a towards the to-be-evaluated joint 12, and which converts an electrical signal received from the ultrasonic unit 102 into an ultrasound signal 15a; and (ii) an ultrasound signal receiver or receiving transducer 14b positionable to detect a reflection 15b of the ultrasound signal 15a. The system 100 may further comprise a processor 106, a non-transient, computer-readable memory 108 including instructions executable by the processor 106 and further including first data relating to a plurality of first sample joints 12 of acceptable quality and second data relating to a plurality of second sample joints 12 of unacceptable quality; and an output device 110. It will be appreciated that components identified herein in the singular include, where appropriate, the plural form, and vice versa, as noted above. For example, the output device 110 may include a plurality of output devices 110, including a display 110a and an indicator light 110b, for example (as described in further detail below). The ultrasonic unit 102, the non-transient, computer-readable memory 108, and the output device 110 may be communicatively coupled to the processor 106.

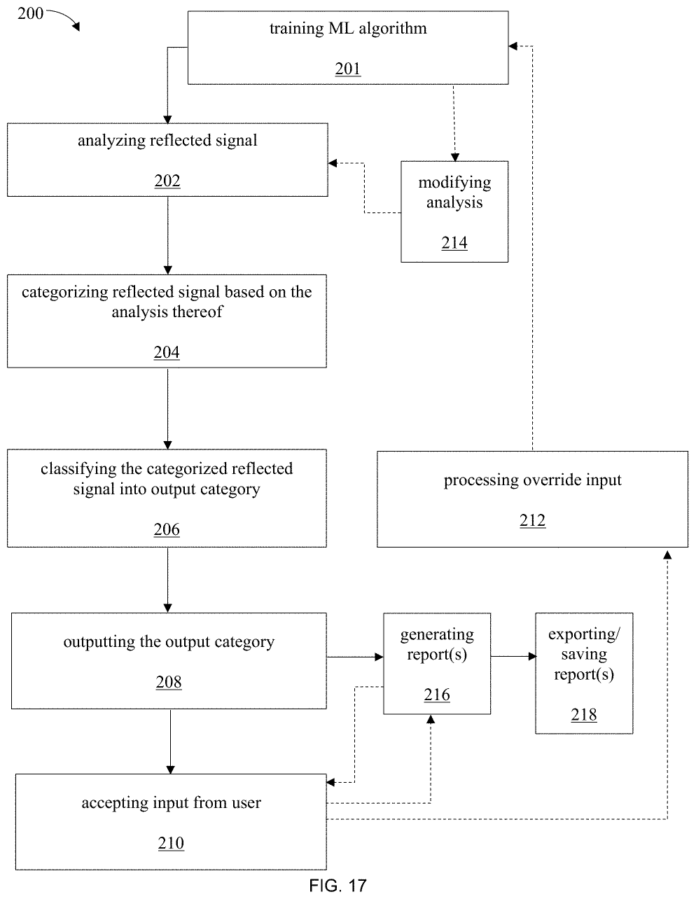

With reference to FIG. 17, the instructions may include instructions for carrying out any of the methods described herein. For example, in some aspects the instructions, and in particular the ML algorithm thereof (the term “ML algorithm” as used herein referring to any suitable DL or Al or ML algorithm that may be suitably trained for the various aspects described herein), may be trained, as described above, for analysis 202 of the to-be-evaluated joint 12 (as described above) and to send 208 assessment output to the output device 110 that is indicative of whether the to-be-evaluated joint 12 is of acceptable quality or unacceptable quality, based on the reflection 15b of the ultrasound signal 15a, and based on the first data and the second data. As described above, the ML algorithm may be a Convolutional Neural Network (CNN) algorithm.

In some aspects, the instructions, and in particular the ML algorithm thereof, may be trained to analyze 202 and categorize 204 the to-be-evaluated joint 12 (and in particular, each ultrasound A-scan signal 15b reflected from the joint 12, and resulting from signals 15a emitted from the transducer 14 of the system 100) into one of at least seven types based on the reflection 15b of the ultrasound signal 15a, and based on the first data and the second data. For example, the at least seven types may include: a flawless or acceptable type (i.e., a joint 12 containing no, or an acceptable level of, defects 16); a void type (i.e., a joint 12 containing void(s)); a dust type (i.e., a joint 12 containing dust contamination); a dirt type (i.e., a joint 12 containing dirt contamination); a grass type (i.e., a joint 12 containing grass contamination); a minor cold fusion (CF) type (i.e., a joint 12 comprising a minor cold fusion flaw); and a severe cold fusion (CF) type (i.e., a joint 12 comprising a severe cold fusion flaw). As such, the instructions may in some aspects include instructions for carrying out a method 200, which may include, e.g., analyzing 202 the reflected signal 15b, categorizing 204 the reflected signal 15b based on the analyzing 202, classifying 206 the categorized reflected signal 15b into an output category, and outputting 208 the output category.

For example, in some aspects, despite having categorized 204 the reflected signals 15b into one of the above seven categories or types, the instructions may include instructions for the ML algorithm to classify 206 the to-be-evaluated joint 12 into one of at east two types based on the reflection 15b of the ultrasound signal 15a, and based on the first data and the second data. For example, the at least two types may include an acceptable type, and an unacceptable type. This may be of value to an operator or user using the system 100 in the field, as outputting 208 a binary indication of acceptable or unacceptable would provide an easy-to-interpret indication to the user as to whether a particular pipe 10 should be installed in the field. Since the ML algorithm is trained to, and does, categorize 204 the analyzed 202 signals 15b into one of the above seven types or categories, the memory 108 may in some aspects maintain such categorizations for future reference (such as for root cause analyses, where a more granular understanding of the root case of a defect 16 may help to mitigate against or eliminate such defects 16 in future pipe 10 production), despite classifying 206 the analyzed 202 reflected signals 15b into, e.g., just two classes (e.g., “acceptable” and “unacceptable”). In other aspects, the categorizing 204 may be into one of the above seven categories, and the classifying 206 may similarly be into one of seven classes corresponding respectively to the seven categories.

In some aspects, the output device 110 may include the indicator light 110b, and the instructions may include instructions for outputting 208 a selected one of a plurality of colors, via the indicator light 110b. In some aspects, the selected one of the plurality of colors may be dependent on the type of the to-be-evaluated joint 12 determined 206 by the ML algorithm. For example, in some aspects, the color outputted 208 to the indicator light 110b may include one of two colors respectively corresponding to one of two output categories resulting from the classifying 206 of the categorized reflected signal 15b into an output category. For example, where the output category is either “acceptable” or “unacceptable”, as described above, the instructions may include instructions for the processor 106 to cause the indicator light 110b to output a green color for the “acceptable” output category, and a red color for the “unacceptable” output category. Similarly, seven or fewer different colors may be selected for respective seven or fewer output categories (for example, dust, dirt and grass may be classified 206 into a single “contamination” output category, and/or minor CF and severe CF may be classified 206 into a single “cold fusion” output category, so as to yield four output categories (acceptable, void, cold fusion, and contamination)), as described above, which may provide an operator or user of the system 100 in the field with more granular information of the type of defect 16 encountered in a pipe joint 12, readily accessible in real-time during scanning of the pipe joint 12 as the instructions cause the processor 106 to classify 206 and output 208 the analyzed 202 and categorized 204 reflected signals 15b.

In some aspects, the system 100 may further comprise an input device 112 which, as described above, may comprise multiple input devices 112 (such as a keyboard 112 and a mouse 112). The input device(s) 112 may, e.g., comprise a computing device 112 for communicatively interfacing with the system 100, as shown in FIG. 15 (not to scale). The input device(s) 112 may be communicatively coupled to the processor 106, such as via a communication interface 114 which may include, e.g., a general-purpose input/output (GPIO) 114 for connecting at least some of the inputs and outputs to the system 100. The communication interface 114 may, e.g., be connected to a connection hub (such as a USB hub) 116 accessible to a user of the system 100 from an exterior of the system 100 (as shown in FIG. 15) for connecting input devices 112 (e.g., a keyboard 112 or mouse 112) and/or output devices 110 (e.g., a hard drive, such as a USB thumb drive 110, to which reports may be exported (as described further, below)).

In some aspects, the instructions may include instructions for accepting 210 an input from a user, such as an override input for changing the type classified 206 (or categorized 204) by the ML algorithm. For example, the instructions, such as the ML algorithm thereof, may cause the processor 106 to classify 206 a joint 12 with a minor CF flaw (e.g., where the pipes 10 were allowed to cool for, e.g., 60 seconds prior to forming a BF joint therebetween by abutting the pipe ends) into an output category of “unacceptable”, and the user may determine (such as by destructive analysis of the joints 12 of pipes having previously been similarly classified 206) that such joint classifications are acceptable for the particular purpose of the pipes 10, and the user may accordingly enter, such as via an input device 112 (e.g., a keyboard 112 and mouse 112 connected to the USB hub 116 and to the communication interface 114 of the system 100) an override instruction for that classification 206 (and/or categorization 204), which override may then be accepted 210 by the system 100. In some aspects, the instructions may further include instructions for processing 212, by the ML algorithm, the override input from the user, further training 201 the ML algorithm based on the processed 212 override input, and modifying 214 the analysis (or the analyzing 202) by the ML algorithm on a subsequent to-be-evaluated joint 12, so that, e.g., the ML algorithm learns to no longer classify 206 a minor CF flaw of the type described above into the “unacceptable” class. Modifying 214 the analysis may mean any or all of modifying the analyzing 202, the categorizing 204 and/or the classifying 206. Further, accepting 210 the override input from the user may be to modify 214 the analyzing 202, categorizing 204 and/or classifying 206 in some manner other than that described above.

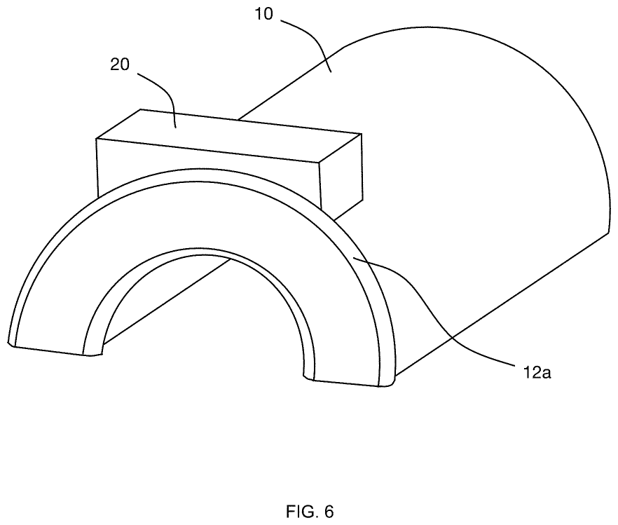

As described above, with reference to FIGS. 3A and 3B, in some aspects, for convenience of operation and/or increased durability for in-field use, the ultrasound signal transmitter (or transmitting transducer) 14a and the ultrasound signal receiver (or receiving transducer 14b) may both be encased in a transducer housing 20 that is shaped to accommodate a cylindrical pipe geometry of the pipe 10, such that the transducer 14 can be moved about a circumference of the pipe 10 while maintaining contact with the pipe 10 across an engagement surface 22 of the transducer 14 (14a, 14b) that is selected to permit pass-through of the ultrasound signal 15a and the reflection of the ultrasound signal 15b. Furthermore, in some aspects, where, e.g., the to-be-evaluated joint 12 is a butt-fusion (BF) joint 12, the transducer 14 (or the transducer housing 20) may be further shaped to abut against a joint bead 12a of the to-be-evaluated joint 12 (see, e.g., FIGS. 5B and 6), and to guide movement of the transducer 14 about the circumference of the pipe 10 at a consistent distance from the to-be-evaluated joint 12. For example, movement of the transducer 14 about the circumference of the cylindrical pipe 10, while abutting the joint bead 12a via the housing 20, may, e.g., facilitate movement of the transducer along a path of the joint bead 12a so as to thereby maintain the transducers at a consistent distance from the to-be-evaluated joint 12.

In some aspects, the system 100 may be designed for ruggedness and durability (as described above with respect to the transducer 14), and further, may be sufficiently lightweight to be carried by a user for in-field evaluation of the to-be-evaluated joint 12. For example, an example of the system 100 shown in FIGS. 15 and 16 is ˜13 lbs (excluding any external components, such as input device(s) 112 connected to the system 100), although it will be appreciated that through selection of alternative materials, fewer components and/or smaller components, the weight of the system 100 may be reduced even further. For example, the output device 110 may include only one of the indicator light 110b and the display 110a in some aspects, and a separate light controller 118 (such as the Arduino Uno™ microcontroller 118 shown in FIG. 16) may not be required to control light output via the indicator light 110b (e.g., in some aspects, such lighting output may be controlled by an onboard controller on the controller 120 (which, in the example shown, comprises a Raspberry Pi 4™). In some aspects, the ultrasonic unit 102, the memory 108, and the processor 106 may be housed within a carrying case 122, which may be formed from a durable hard plastic, for example, to further contribute to the durability and/or ruggedness of the system 100 for in-field use. The carrying case 122 may be openable, such as by lifting a lid 122a thereof attached to a body 122b thereof, such as by hinged connection (not shown), in order to access the internal components. In some aspects, the lid 122a may be releasably lockable to the body 122b. As shown in FIGS. 15 and 16, the transducer 14 may be connected to the ultrasonic unit 102 by an electrically conductive cable 104 extending from within the carrying case 122 to outside the carrying case 122, such that the transducer 14 is operable outside the carrying case, remote from the ultrasonic unit 102. In some aspects, as shown in FIG. 15, the display 110a and the indicator light 110b may be visible from the outside of the carrying case 122, to facilitate the conveying 208 of outputs to a user of the system 100.

As previously described, the system 100 may, via the ultrasonic unit 102 and transducer 14, generate and receive ultrasound signals 15 that are A-scan ultrasound signals having a frequency of about 1.8 MHz. In some aspects, the ultrasound system 100 may further comprise a save button 124, which may be positioned on the outside of the carrying case 122 (as shown in FIG. 15) for easy access by a user of the system 100. The save button 124 may be communicatively coupled to the processor 106, and the instructions may include instructions to save the analysis 202, 204, 206, and/or 208 of a respective reflected ultrasound signal 15b by the ML algorithm to the memory 108 upon activation of the save button 124 by the user. For example, a user may determine that for a given diameter of PE pipe 10, a particular number of ultrasound scans should be taken of the joint 12 as the transducer 14 is moved about the circumference of the pipe 10 in appropriate proximity to the plane 18 of the joint 12 (such as, e.g., 12 A-scans generally evenly spaced apart around the circumference of the pipe joint 12). The system 100 may begin to emit A-scan ultrasound signals 15a, such as continuously or at discrete intervals, upon powering of the system 100, such as by activating a power switch 126 of the system 100 (which would be required to be connected to a power source (not shown), such as a portable battery pack for in-field use, or an electrical supply from a nearby generator or building, for example). The power switch 126 may be communicatively coupled to a power supply interface 128 (such as the USB-C power supply interface 128 of the Raspberry Pi 4™) for powering the controller 120 and all components thereon (such as the processor 106). Further components of the system 100 may be communicatively coupled to the power switch 126 by power connections 130 thereof, such as via an intermediate power bar 132 (which, in some aspects, may not be required, such as where components of the system 100 are communicatively coupled directly to the power switch 126).

In some aspects, the communication interface 114 may include, e.g., one or more ethernet ports 134, one or more USB ports 136 and one or more HDMI ports 138, for example, such as to effect the communicative coupling of the processor 106 to other components, such as the ultrasonic unit 102, the indicator light controller 118, and the display 110a (each of which similarly comprises such ports). For example, as depicted in the example shown in FIG. 16, a display 110a may be connected to the controller 120 and the processor 106 by both a USB connection (via USB ports 136) and an HDMI connection (via HDMI ports 138).

In some aspects, the instructions may further include instructions for generating 216 one or more reports of the analysis (including any part thereof, such as of the analyzing 202, categorizing 204, classifying 206, and/or outputting 208), and exporting and/or saving 218 the one or more reports to the memory 108 and/or to one or more output devices 110 (such as a USB thumb drive 110 connected to the system 100 via the connection hub 116 and the communication interface 114). In some aspects, the instructions may further include the instructions for accepting 210 input from a user, such as by an input device 112 (e.g., a keyboard 112 and a mouse 112 connected to the connection hub 116 and the communication interface 114), to modify the one or more reports, in which case the method 200 may further comprise generating 216 the report(s) again, after such input from the user has been accepted 210.

In some aspects, the system 100 is switchable between use with BF joints 12 and use with EF joints 12. For example, in accordance with some aspects there is provided an ultrasound system 100 for non-destructive evaluation (NDE) of a butt-fusion (BF) joint 12 of a first pair of pipes 10 and an electro-fusion (EF) joint 12 of a second pair of pipes 10. The ultrasound system 100 may comprise: a base unit 140 (which may in some aspects comprise some or all of the components shown in the figures within the carrying case 122, and in further aspects, may also include the carrying case 122) that includes a power supply interface 128 positioned for connection to a power source, an output device 110, a first signal connector 142 (which, as shown in FIG. 16, may comprise a pair or more of first signal connectors 142), and a controller 120 that includes a processor 106 and a non-transient, computer-readable memory 108 including instructions executable by the processor 106. The power supply interface 128, the output device 110, the first signal connector 142, and the memory 108 may be communicatively coupled to the controller 120 and the processor 106 thereof.

In some aspects the ultrasound system 100 may further comprise a butt-fusion transducer 144 that includes a second signal connector 146 (which, as shown in FIGS. 3A and 3B, may comprise a pair or more of the second signal connectors 146, such as LEMO™ 00 Series circular push pull connector(s) 146) that is shaped to releasably connect to the first signal connector 142, so as to form a first electrical connection 147 that permits signal transmission between the butt-fusion transducer 144 and the processor 106. With reference to FIG. 4, the butt-fusion transducer 144 may further include a first ultrasound transmitter 148 that converts first electrical signals received from the controller 120 (such as via an ultrasonic unit 102 communicatively coupled to the controller 120 and the processor 106 thereof, or in some aspects, directly from the controller 120) into a first ultrasound signal 15a, and a first ultrasound receiver 150 is positioned at a selected distance 152 from the first ultrasound transmitter 148. The butt-fusion transducer 144 may include a first engagement surface 22, and the butt-fusion transducer 144 may be positionable in a use position (shown, e.g., in FIGS. 5 and 6) in which the first engagement surface 22 is engaged with at least one pipe 10 from the first pair of pipes 10 such that the first ultrasound transmitter 148 is positioned to transmit the first ultrasound signals 15a towards the butt-fusion joint 12 and the first ultrasound receiver 150 is positioned to receive a reflection 15b of the first ultrasound signal 15a from the butt-fusion joint 12 and to transmit first receiver output to the controller 120 (such as to the processor 106 thereof) via the first electrical connection 147.

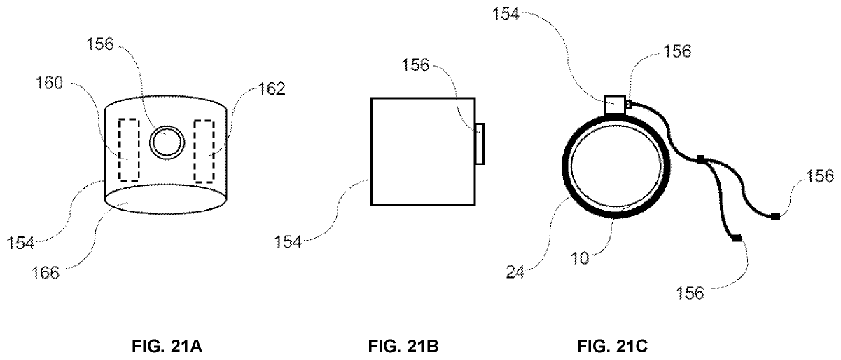

In some aspects the ultrasound system 100 may further comprise an electro-fusion transducer 154 that includes a third signal connector 156 (which, as shown in FIGS. 21A, 21B and 21C, may comprise a pair or more of the third signal connectors 156, such as a third signal connector 156 that branches into a pair of third signal connectors 156 (such as BNC (“Bayonet Neill-Concelman”) connectors 156)) that is shaped to releasably connect to the first signal connector 142, so as to form a second electrical connection 158 that permits signal transmission between the electro-fusion transducer 154 and the processor 106. The electro-fusion transducer 154 may further include a second ultrasound transmitter 160 that converts second electrical signals received from the controller 120 (such as via an ultrasonic unit 102 communicatively coupled to the controller 120 and the processor 106 thereof, or in some aspects, directly from the controller 120) into a second ultrasound signal 15a, and a second ultrasound receiver 162. The electro-fusion transducer 154 may include a second engagement surface 166, and the electro-fusion transducer 154 may be positionable in a use position (shown, e.g., in FIG. 21C) in which the second engagement surface 166 is engaged with at least one pipe 10 from the second pair of pipes 10 (the electro-fusion (EF) fitting 24 being considered part of the pipe 10 once the EF joint 12 is formed by heat applied to the second pair of pipes 10 via the EF fitting 24, the portion of the EF fitting 24 over a pipe 10 being considered part of that pipe 10) such that the second ultrasound transmitter 160 is positioned to transmit the second ultrasound signals 15a towards the electro-fusion joint 12 and the second ultrasound receiver 162 is positioned to receive a reflection 15b of the second ultrasound signal 15a from the electro-fusion joint 12, and to transmit second receiver output to the controller 120 (such as to the processor 106 thereof) via the second electrical connection 158.

In some aspects, the EF transducer 154 may include a single transducer capable of carrying out the functions of both the second ultrasound transmitter 160 and the second ultrasound receiver 162, rather than the dual element-type transducer 154 shown in FIGS. 21A, 21B and 21C. In such aspects, the second ultrasound transmitter 160 and the second ultrasound receiver 162 have the meaning of a second ultrasound transmitter function 160 and a second ultrasound receiver function 162, respectively, even where the term “function” is omitted. Further, while a 1-to-2 type set of third signal connectors 156 are shown in FIG. 21C, it will be appreciated that any suitable connectors 146, 156 may be used, depending on the types of BF and EF transducers 144, 154 used.

In some aspects, the ultrasonic unit 102 may operate in a “pitch-catch” mode when connected via both the “IN” 102a and “OUT” 102b connectors on the ultrasonic unit 102 to a transducer 14 having separate transmitting and receiving transducers 14a, 14b (e.g., separate piezo elements) and connectors therefor (as shown in FIGS. 15 and 16). Further, the ultrasonic unit 102 may operate in a “pulse-echo” mode when connected, by the “IN” connector 102a on the ultrasonic unit 102 only, for example, to a transducer 14 having a single transmitting and receiving transducer 14 (e.g., a single piezo element) and connector therefor, in which case the “OUT” connector 102b on the ultrasonic unit 102, for example, would remain disconnected from the transducer 14. The carrying case 122 may be labeled on the exterior thereof with “IN” and “OUT” above respective connectors 141, so as to indicate to a user which connections on the ultrasonic unit 102 (“IN” or “OUT”) lead to the respective “IN” and “OUT” connectors 141 accessible from the exterior of the carrying case 122; this would avoid the need to open the carrying case 122 to confirm which cable 104 is the “IN” cable, and which cable 104 is the “OUT” cable. In further aspects, the carrying case 122 may, alternatively, have a opening formed therein (not shown) that exposes the front panel of the ultrasonic unit 102 and the “IN” and “OUT” connectors 102a, 102b thereof.

In some aspects, the instructions may include instructions for selecting between a BF inspection mode (which may comprise a “pitch-catch” mode for the ultrasonic unit 102) and an EF inspection mode (which may comprise a “pulse-echo” mode for the ultrasonic unit 102), based on input by a user, such as via selection of one of the Butt Fusion Joint Inspection Session GUI element 168a and the Electro-Fusion Joint Inspection Session GUI element 168b. The instructions may include instructions for the processor 106 to indicate to a processor of the ultrasonic unit 102 which mode (BF inspection or EF inspection) has been selected and therefore which mode (for example, pitch-catch or pulse-echo, respectively) the ultrasonic unit 102 should operate in. It will be appreciated that EF inspection may also use dual element transducers 14, as described above, in which case the ultrasonic unit 102 may operate in a pitch-catch mode for an EF inspection; the GUI elements 170a, 170b may be amended, as required, to address this, such as by changing the “Butt Fusion Joint Inspection Session” element 168a and the “Electro-Fusion Joint Inspection Session” element 168b to a “Dual Element Transducer Inspection” (or “Pitch-Catch mode”) element and a “Single Element Transducer Inspection” (or “Pulse-Echo mode”) element, respectively, so that the user is selecting the appropriate transducer type for the inspection (rather than the type of pipe joint 12 (BF or EF) to be inspected) and the processor 106 thus appropriately instructs the processor of the ultrasonic unit 102 as to the mode in which the ultrasonic unit 102 should operate (i.e., pitch-catch or pulse-echo).

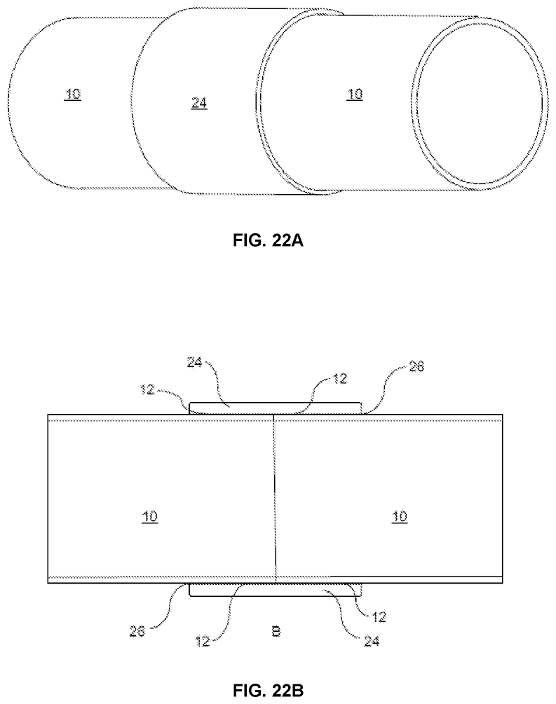

As shown in FIG. 22B, the plane 26 of an EF joint 12 is different from the plane 18 of a BF joint 12, in that the EF joint plane 26 extends across the contacting surfaces of the pipes 10 and the EF fitting 24 through which heat is applied to fuse the pipes 10 to the EF fitting 24 (and not, as in BF pipe joints 12, to each other). As such, it is not necessary, for EF transducers 154, to space or to angle separate transmitting and receiving transducers 14a, 14b to the extent required for the above-described BF transducers 144 in order to accommodate pipe geometry and optimize side introduction of the signals 15 to and from the BF joint 12. Instead, EF transducers 154 can be moved over that portion of the pipe 10 formed from the EF fitting 24 and transmit the signals 15a generally downward, toward the plane 26 directly beneath the EF transducer 154, and so the challenges of effective signal 15 propagation to the joint plane 18 presented with respect to BF joints 12 do not exist for EF joints 12 (although some angling of the second ultrasound transmitter 160 and the second ultrasound receiver 162, such as where the EF transducer 154 is a dual-element EF transducer 154, as shown in FIG. 21A, may be present, so as to optimize signal 15 propagation from the second ultrasound transmitter 160, toward the EF joint 12 and plane 26 thereof, and toward the second ultrasound receiver 162).

In some aspects, the selected distance 152 is selected so as to accommodate a pipe 10 geometry and size, for good ultrasound signal transmission 15a and reflection 15b from and to the first ultrasound transmitter 148 and the first ultrasound receiver 150, respectively.

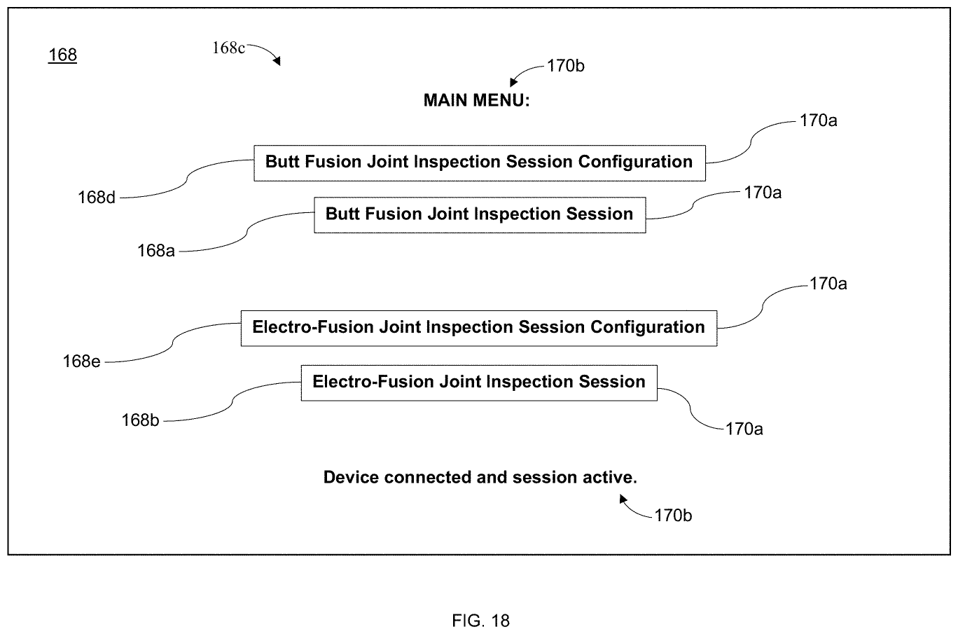

The controller 120 may be operable in a first mode (such as a “butt fusion (BF)” mode, which may, e.g., be selectable from a graphical user interface (GUI) 168 shown on the display 110a (such as by selection of a “Butt Fusion Joint Inspection Session” element 168a of the GUI 168, as shown in FIG. 18), the instructions further including instructions for rendering the GUI 168 on the display 110a and accepting user inputs via input device(s) 112 via the GUI 168) when the second signal connector 146 is connected to the first signal connector 142, in which first mode the controller 120 (such as the instructions thereof) may be programmed to emit butt-fusion assessment output 208 via the output device 110 relating to a quality of the butt-fusion (BF) joint 12 based on the execution of the instructions and the first receiver output.

The controller 120 may also be operable in a second mode (such as an “electro-fusion (EF)” mode), which may, e.g., be selectable from the GUI 168 shown on the display 110a (such as by selection of an “Electro-Fusion Joint Inspection Session” element 168b of the GUI 168, as shown in FIG. 18) when the third signal connector 156 is connected to the first signal connector 142, in which second mode the controller 120 (such as the instructions thereof) may be programmed to emit electro-fusion assessment output 208 via the output device 110 relating to a quality of the electro-fusion (EF) joint 12 based on the execution of the instructions and the second receiver output.

As shown in FIG. 18, in some aspects the GUI 168 may include a Main Menu 168c including the user-selectable elements 168a, 168b for selecting a BF joint inspection session or an EF joint inspection session. The Main Menu 168c may further include elements for “Butt Fusion Joint Inspection Session Configuration” 168d and “Electro-Fusion Joint Inspection Session Configuration” 168e. The term “element” as used herein with respect to the GUI 168 may include any element that is selectable by a user (or a selectable element 170a, such as a virtual button) and/or any element displaying non-selectable information to a user (or a non-selectable element 170b). In some aspects, the display 110a may be a touch-sensitive display 110a capable of receiving user touch input of selectable elements 170a of the GUI 168. In other aspects, the user-selectable elements 170a of the GUI 168 may alternatively, or additionally, be selectable by an input device 112 (such as a mouse 112 and/or a keyboard 112 connected to system 100, such as to the connection hub 116 and the communication interface 114).

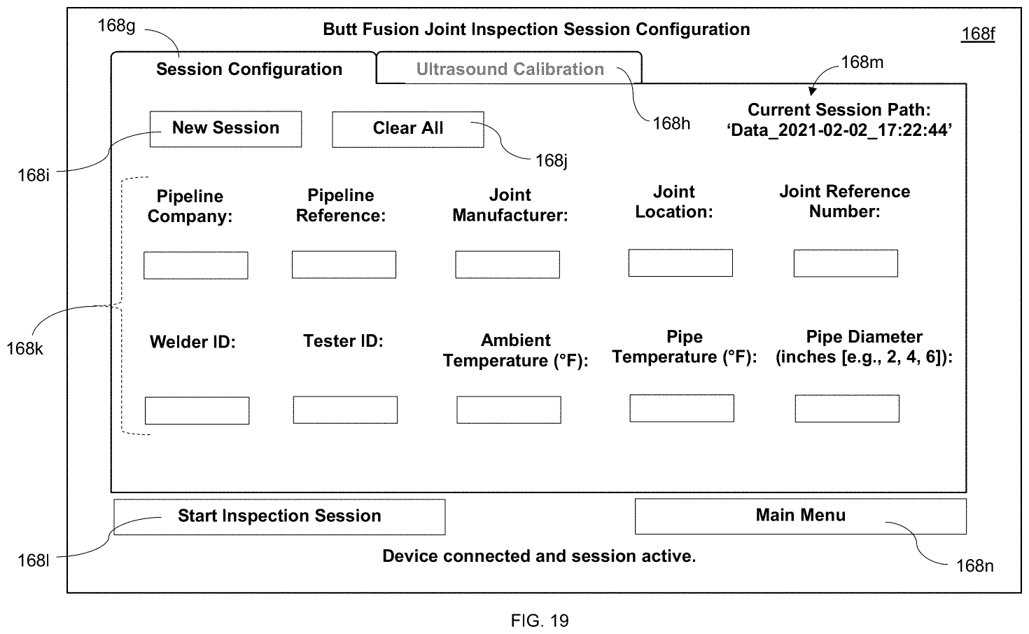

With reference to FIG. 19, in some aspects, the instructions may further include instructions for displaying a Configuration Menu 168f, such as is selectable by the session configuration elements 168d, 168e described above (while only the Butt Fusion Joint Inspection Session Configuration menu 168f is shown, it will be appreciated that the Electro-Fusion Joint Inspection Session Configuration menu 168f may be similarly configured). The configuration menu 168f may include, for example, a Session Configuration sub-menu 168g (which is shown as selected in the example configuration menu 168f shown in FIG. 19) and an Ultrasound Calibration sub-menu 168h (which is shown as unselected in the example configuration menu 168f shown in FIG. 19) which may include calibration tools for the ultrasound system 100. As shown in the example configuration menu 168f shown in FIG. 19, the configuration menu 168f may include, e.g., selectable buttons for beginning a new session 168i and for clearing all entries 168j, and text entry fields with corresponding labels 168k for a user to enter, such via a keyboard 112, values for one or more of the fields 168k, which may include fields 168k for, e.g., “Pipeline Company:”, “Pipeline Reference:”, “Joint Manufacturer:”, “Joint Location:”, “Joint Reference Number:”, “Welder ID:”, “Tester ID:”, “Ambient Temperature (° F):”, “Pipe Temperature (° F):”, and “Pipe Diameter (inches [e.g., 2, 4, 6]):”). The instructions may include instructions for saving such information from a user, entered into the fields 168k (as well as calibration information or settings obtained via calibration of the system 100 via the calibration sub-menu 168h) to the memory 108, and further, to associate any such information with an inspection session (which may be started by a user by selecting the “Start Inspection Session” element 168l and which may be given a unique session path or ID 168m in the memory 108 with which all such information may be associated). Such saved information may be useful, in conjunction with the results 208 of the ultrasound scans of the pipe joint 12, and may be included in the reports that are generated 216. As shown in FIG. 19, by selection of a “Main Menu” element 168n, a user may return to the main menu.

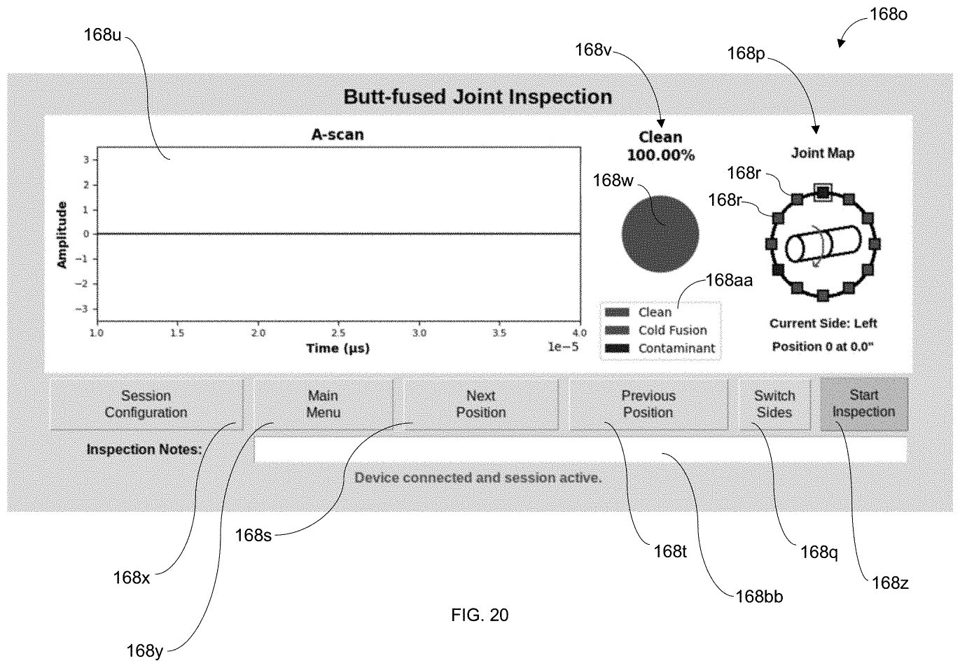

With reference to FIG. 20, in some aspects, the outputting 208 by the system 100, in addition to, or as an alternative to, the various outputs described above (including, but not necessarily limited to, the reports generated 216 by the system 100 and/or the indicator light 110b color outputs), the instructions may further include instructions for outputting 208 the output category(ies) to the GUI 168, such as by generating 216 a report 168o on the display 110a, an example of which is shown in the example report 168o shown in FIG. 20. Such report 168o may be interactive and may include, e.g., a joint map 168p, which may include a schematic depiction of (i) the pair of pipes 10 joined by the joint 12 that was the subject of the ultrasound scan(s), and/or (ii) a result of each scan that was carried out for a particular side of the joint 12 (which may, e.g., be shown in a circular configuration about the schematic depiction of the pair of pipes 10, as shown in the example layout of FIG. 20), which result may include, e.g., a color-coded indication of a class of the scan result as classified 206 by the ML algorithm (such as green for “Clean” (or “Flawless” or “Acceptable”), red for “Cold Fusion” and blue for “Contaminant”, as shown in the example classifications of FIG. 20). A user may view the scan results for a desired side of the joint 12 by selecting the “Switch Sides” element 168q, and further, may transition from one scan result 168r to the next or previous scan result 168r on the joint map 168p by selecting the “Next Position” element 168s and the “Previous Position” element 168t, respectively. The scan result 168r selected on the joint map 168p may be highlighted or otherwise may be indicated as being selected (such as by surrounding the scan result 168r with a graphical element (such as a box), as shown for the top-most scan result 168r shown in FIG. 20). For each selected scan result 168r of the joint map 168p, the report 168o on the GUI 168 may display further information regarding the scan result 168r, such as an A-scan graph 168u showing the corresponding A-scan result (showing the reflected ultrasound signal 15b for the selected scan result 168r as a function of amplitude vs time (such as in ps), for example), and/or a general indicator 168v of the percent of the scan result 168r that is clean (or flawless or acceptable), which may include a pie chart 168w depicting the percentage result (for example, a result 168r classified as “acceptable” or “clean”, and therefore shown as green around the schematic depiction of the pair of joined pipes 10, may have actually been 99.85% clean (which percentage may be indicated in the corresponding indication and pie chart 168v, 168w) and since determined by the ML algorithm to be sufficiently devoid of defects 16, classified 206 as “clean”). The report GUI 168o may further include an element 168x for switching to the session configuration menu, an element 168y for returning to the main menu, and an element 168z for starting an inspection. The report GUI 168o may further include a legend 168aa indicating the color-coding for each classification of joint type shown around the schematic depiction of the joined pair of pipes 10 in the joint map 168p, and an “Inspection Notes:” field 168bb, in which a user may enter text notes, such as by a connected keyboard 112, for the selected scan result 168r. As described above, the instructions may include instructions to export and/or save 218 the report 168o, including any manual notes entered by a user into the inspection notes field 168bb for any scan results 168r, in a format appropriate for non-interactive review of the report 168o (e.g., each scan result 168r and its associated information may be shown on a separate page or section of the exported/saved report 168o, making it suitable for printing, for example).

In some aspects, the system 100 may be for use only for inspection of BF joints 12 (as depicted in the example system 100 shown in FIGS. 15 and 16, which includes the transducer 144 for BF joint 12 analysis), and in other aspects, the system 100 may be for use only for inspection of EF joints 12 (and so includes only the transducer 154 shown in FIGS. 21A, 21B and 21C). In such aspects, GUI elements may be modified so as to omit unnecessary elements (such as those pertaining only to the unused type of transducer 14).

By automating in-field NDE of BF and/or EF PE pipe joints 12 in the field through DL/AI/ML, it is expected that NDE accuracy will be enhanced through use of the system 100. Further, DL/AI/ML-based evaluation of NDE data is expected to provide a means of rapid, accurate, and consistent data interpretation.

Any of the aspects described herein may be combined in any suitable manner. Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. An ultrasound device for non-destructive evaluation of a to-be-evaluated joint between a pair of pipes, wherein the to-be-evaluated joint is one of a butt-fusion joint and an electro-fusion joint, the ultrasound device comprising:
an ultrasonic unit;
a transducer communicatively coupled to the ultrasonic unit and operable remotely from the ultrasonic unit, the transducer including
an ultrasound signal transmitter that converts an electrical signal received from the ultrasonic unit into an ultrasound signal, the transmitter positionable to transmit the ultrasound signal towards the to-be-evaluated joint, and
an ultrasound signal receiver positionable to detect a reflection of the ultrasound signal;
a processor;
a non-transient, computer-readable memory including instructions executable by the processor, and further including first data relating to a plurality of first sample joints of acceptable quality and second data relating to a plurality of second sample joints of unacceptable quality; and
an output device,
wherein the ultrasonic unit, the non-transient, computer-readable memory, and the output device are communicatively coupled to the processor,
and wherein the instructions include a machine learning (ML) algorithm trained for analysis of the to-be-evaluated joint and to send assessment output to the output device that is indicative of whether the to-be-evaluated joint is of acceptable quality or unacceptable quality, based on the reflection of the ultrasound signal, and based on the first data and the second data.

2. The ultrasound device of claim 1, wherein the ML algorithm is a Convolutional Neural Network (CNN) algorithm.

3. The ultrasound device of claim 2, wherein the ML algorithm classifies the to-be-evaluated joint into one of at least two types based on the reflection of the ultrasound signal, and based on the first data and the second data, the at least two types including: an acceptable type, and an unacceptable type.

4. The ultrasound device of claim 2, wherein the ML algorithm is trained for classification of the to-be-evaluated joint into one of at least seven types based on the reflection of the ultrasound signal, and based on the first data and the second data, the at least seven types including: an acceptable type; a void type; a dust type; a dirt type; a grass type; a minor cold fusion (CF) type; and a severe cold fusion (CF) type.

5. The ultrasound device of claim 1, wherein the ultrasound device is sufficiently lightweight to be carried by a user for in-field evaluation of the to-be-evaluated joint.

6. The ultrasound device of claim 1, wherein the ultrasound signal transmitter and the ultrasound signal receiver are both encased in a transducer housing shaped to accommodate a cylindrical pipe geometry of the pipe such that the transducer can be moved about a circumference of the pipe while maintaining contact with the pipe across an engagement surface of the transducer that is selected to permit pass-through of the ultrasound signal and the reflection of the ultrasound signal.

7. The ultrasound device of claim 6, wherein the to-be-evaluated joint is a butt-fusion joint and the transducer housing is further shaped to abut against a joint bead of the to-be-evaluated joint, and to guide movement of the transducer about the circumference of the pipe at a consistent distance from the to-be-evaluated joint.

8. The ultrasound device of claim 1, wherein the ultrasound signal is an A-scan ultrasound signal having a frequency of about 1.8 MHz.

9. The ultrasound device of claim 2, wherein the output device includes an indicator light, the instructions including instructions for outputting a selected one of a plurality of colors, via the indicator light, wherein the selected one of the plurality of colors is dependent on the type of the to-be-evaluated joint determined by the ML algorithm.

10. The ultrasound device of claim 2, wherein the instructions include instructions for accepting override input from the user, for changing the type classified by the ML algorithm, the instructions further including instructions for the ML algorithm to process the override input from the user to further train the ML algorithm and modify the analysis by the ML algorithm on a subsequent to-be-evaluated joint.

11. An ultrasound system for non-destructive evaluation of a butt-fusion joint of a first pair of pipes and an electro-fusion joint of a second pair of pipes, the ultrasound system comprising:
a base unit that includes
a power supply interface positioned for connection to a power source,
an output device,
a first signal connector, and
a controller that includes a processor and a non-transient, computer-readable memory including instructions executable by the processor, wherein the power supply interface, the output device, the first signal connector, and the memory are communicatively coupled to the processor;
a butt-fusion transducer that includes a second signal connector that is shaped to releasably connect to the first signal connector, so as to form a first electrical connection that permits signal transmission between the butt-fusion transducer and the processor, wherein the butt-fusion transducer further includes a first ultrasound transmitter that converts first electrical signals received from the controller into a first ultrasound signal, and a first ultrasound receiver is positioned at a selected distance from the first ultrasound transmitter, wherein the butt-fusion transducer includes a first engagement surface, wherein the butt-fusion transducer is positionable in a use position in which the first engagement surface is engaged with at least one pipe from the first pair of pipes such that the first ultrasound transmitter is positioned to transmit the first ultrasound signals towards the butt-fusion joint and the first ultrasound receiver is positioned to receive a reflection of the first ultrasound signal from the butt-fusion joint and to transmit first receiver output to the controller via the first electrical connection; and
an electro-fusion transducer that includes a third signal connector that is shaped to releasably connect to the first signal connector, so as to form a second electrical connection that permits signal transmission between the electro-fusion transducer and the processor, wherein the electro-fusion transducer further includes a second ultrasound transmitter that converts second electrical signals received from the controller into a second ultrasound signal, and a second ultrasound receiver, wherein the electro-fusion transducer includes a second engagement surface, wherein the electro-fusion transducer is positionable in a use position in which the second engagement surface is engaged with at least one pipe from the second pair of pipes such that the second ultrasound transmitter is positioned to transmit the second ultrasound signals towards the electro-fusion joint and the second ultrasound receiver is positioned to receive a reflection of the second ultrasound signal from the electro-fusion joint, and to transmit second receiver output to the controller via the second electrical connection,
wherein the controller is operable in a first mode when the second signal connector is connected to the first signal connector, wherein in the first mode the controller is programmed to emit butt-fusion assessment output via the output device relating to a quality of the butt-fusion joint based on the execution of the instructions and the first receiver output, and
wherein the controller is operable in a second mode when the third signal connector is connected to the first signal connector, wherein in the second mode the controller is programmed to emit electro-fusion assessment output via the output device relating to a quality of the electro-fusion joint based on the execution of the instructions and the second receiver output.
